(19) United States
(12) Patent Application Publication
(10) Pub. No.: US 2024/0184272 A1
(43) Pub. Date: Jun. 6, 2024

(54) MACHINE LEARNING IN A NON-PUBLIC COMMUNICATION NETWORK

(71) Applicant: Telefonaktiebolaget LM Ericsson (publ), Stockholm (SE)

(72) Inventors: Peter Vaderna, Budapest (HU); Zsófia Kallus, Budapest (HU); Maxime Bouton, Stockholm (SE); Carmen Lee Altmann, Täby (SE)

(21) Appl. No.: 17/969,248

(22) Filed: Oct. 19, 2022

(51) Int. Cl. G05B 19/418

(52) U.S. Cl. CPC G05B 19/4183; G05B 19/4185; G05B 19/41895

(57) ABSTRACT

Equipment that supports a non-public communication network trains a machine learning model with a training dataset to make a prediction or decision in the network. The equipment determines whether the trained model is valid or invalid based on whether predictions or decisions that the trained model makes from a validation dataset satisfy performance requirements. Based on the trained model being invalid, the equipment analyzes the training dataset and/or the trained model to determine what additional training data to add to the training dataset. The equipment transmits signaling for configuring one or more autonomous or automated mobile devices served by the network to help collect the additional training data. The equipment then re-trains the model with the training dataset as supplemented with the additional training data.

### TECHNICAL FIELD

The present application relates generally to a non-public communication network, and relates more particularly to machine learning in such a network.

### BACKGROUND

Machine learning can enhance the ability of a network operator to manage a public communication network in a number of respects. As just some examples, machine learning can improve the operator's ability to correctly analyze the root cause of a performance problem, detect an anomaly in the network (e.g., a false base station), and/or optimize network configuration parameters. Machine learning works well for these and other purposes in a public communication network because the public nature of the network creates an environment naturally conducive to accurate and robust training of machine learning models. Indeed, a public communication network typically extends over a large geographic area and/or serves a large number of devices so as to support the collection of a large amount of training data, with diverse values, for training machine learning models well.

By contrast, a non-public communication network (NPN) intended for non-public use typically extends over a smaller geographic area and/or serves a smaller number of devices than a public communication network. A non-public communication network may for example limit coverage to a certain industrial factory and restrict access to industrial internet-of-things (IoT) devices in that factory. As another example use case, a non-public communication network may be dedicated to an enterprise in an industrial field such as manufacturing, agriculture, mining, ports, etc. Exploiting machine learning proves challenging in such a network, though, because the non-public nature of the network limits the amount and/or type of training data obtainable for training a machine learning model. Limited training data jeopardizes training performance and thereby non-public communication network management

### SUMMARY

Embodiments herein train a machine learning model to make a prediction or decision in a non-public communication network, e.g., for management of the non-public communication network. Some embodiments notably exploit automated or autonomous mobile device(s) served by the non-public communication network to help collect training data for training the machine learning model. Some embodiments for example determine location(s) from which additional training data would be beneficial and re-route automated or autonomous mobile device(s) to the determined location(s) for training data collection, e.g., by revising an automated or autonomous mobile device's route to include a training data collection location as a waypoint in its route. In fact, some embodiments iteratively train and evaluate the machine learning model in this way over multiple rounds of training, and employ automated or autonomous mobile device(s) to collect additional training data in between training rounds, as needed in order to ultimately validate the trained model as satisfying performance requirements. These and other embodiments thereby advantageously capitalize on the automated or autonomous nature of served mobile devices for training data enrichment, e.g., with no or little impact on the otherwise functional value of those served mobile devices. This enrichment may in turn support accurate and robust machine learning training in a non-public communication network, e.g., so that machine learning can prove effective for managing even a non-public communication network.

More particularly, embodiments herein include a method performed by equipment supporting a non-public communication network. The method comprises training a machine learning model with a training dataset to make a prediction or decision in the non-public communication network. In this case, the method further comprises determining whether the trained machine learning model is valid or invalid based on whether predictions or decisions that the trained machine learning model makes from a validation dataset satisfy performance requirements. In this case, the method further comprises, based on the trained machine learning model being invalid, analyzing the training dataset and/or the trained machine learning model to determine what additional training data to add to the training dataset. In this case, the method further comprises transmitting signaling for configuring one or more autonomous or automated mobile devices served by the non-public communication network to help collect the additional training data. In this case, the method further comprises re-training the machine learning model with the training dataset as supplemented with the additional training data.

In some embodiments, analyzing comprises analyzing how impactful different machine learning features represented by the training dataset are to the prediction or decision and selecting one or more machine learning features for which to collect additional training data, based on how impactful the one or more machine learning features are to the prediction or decision.

In some embodiments, analyzing comprises, for each of one or more machine learning features represented by the training dataset, analyzing a number of and/or a diversity of values in the training dataset for the machine learning feature, and selecting one or more machine learning features for which to collect additional training data, based on said number and/or said diversity.

In some embodiments, the method further comprises determining one or more locations, in a coverage area of the non-public communication network, at which to collect the additional training data. In this case, the signaling comprises signaling for configuring the one or more autonomous or automated mobile devices to help collect the additional training data at the one or more locations. In some embodiments, determining the one or more locations at which to collect the additional training data comprises, for each of one or more machine learning features, generating a heatmap representing values of the machine learning feature at different locations in the coverage area of the non-public communication network. In this case, determining the one or more locations at which to collect the additional training data comprises, for each of one or more machine learning features, based on the heatmap, generating a score function representing scores for respective locations in the coverage area of the non-public communication network. In some embodiments, the score for a location quantifies a benefit of collecting additional training data for the machine learning feature at the location. In this case, determining the one or more locations at which to collect the additional training data comprises, for each of one or more machine learning features, based on the score function, selecting one or more locations at which to collect additional training data for the machine learning feature. In some embodiments, the score function represents the score for a location as a function of a number of and/or a diversity of values in the training dataset for the machine learning feature at the location. In other embodiments, the score function alternatively or additionally represents the score for a location as a function of an accuracy of the machine learning model at the location. In yet other embodiments, the score function alternatively or additionally represents the score for a location as a function of an uncertainty of the machine learning model at the location. In some embodiments, the signaling comprises, for each of at least one of the one or more autonomous or automated mobile devices, signaling for routing the autonomous or automated mobile device to at least one location of the one or more locations to help collect at least some of the additional training data. In some embodiments, the signaling revises a route of the autonomous or automated mobile device to include the at least one location as a destination or waypoint in the route. In some embodiments, for each of at least one of the one or more autonomous or automated mobile devices, the signaling comprises signaling for configuring the autonomous or automated mobile device to perform one or more transmissions of test traffic at one or more of the one or more locations. In other embodiments, for each of at least one of the one or more autonomous or automated mobile devices, the signaling comprises signaling for configuring the autonomous or automated mobile device to alternatively or additionally perform one or more measurements at one or more of the one or more locations and to collect the results of the one or more measurements as at least some of the additional training data.

In some embodiments, the method further comprises solving an optimization problem that optimizes a data collection plan for each of the one or more autonomous or automated mobile devices, subject to one or more constraints. In this case, a data collection plan for an autonomous or automated mobile device includes a plan on what training data the autonomous or automated mobile device will help collect and what route the autonomous or automated mobile device will take as part of helping to collect that training data. In some embodiments, the one or more constraints include a constraint on movement dynamics of each of the one or more autonomous or automated mobile devices. In other embodiments, the one or more constraints alternatively or additionally include a constraint on allowed deviation from a production route of each of the one or more autonomous or automated mobile devices. In yet other embodiments, the one or more constraints alternatively or additionally include a constraint on an extent to which collection of additional training data is allowed to disturb the non-public communication network. In some embodiments, a score function for a machine learning feature represents scores for respective locations in the coverage area of the non-public communication network. In this case, the score for a location quantifies a benefit of collecting additional training data for the machine learning feature at the location, and solving the optimization problem comprises maximizing the score function over a planning time horizon, subject to the one or more constraints.

In some embodiments, the training data includes performance management data and/or configuration management data for the non-public communication network.

In some embodiments, the prediction is a prediction of one or more key performance indicators, KPIs.

In some embodiments, the non-public communication network is an industrial internet-of-things network. In this case, the autonomous or automated mobile devices are each configured to perform a task of an industrial process, and the autonomous or automated mobile devices include one or more automated guided vehicles, one or more autonomous mobile robots, and/or one or more unmanned aerial vehicles.

In some embodiments, the method further comprises, after validating the re-trained machine learning model, using the re-trained machine learning model for root-cause analysis, anomaly detection, or network optimization in the non-public communication network.

Other embodiments herein include equipment configured to support a non-public communication network. The equipment is configured to train a machine learning model with a training dataset to make a prediction or decision in the non-public communication network. In this case, the equipment is also configured to determine whether the trained machine learning model is valid or invalid based on whether predictions or decisions that the trained machine learning model makes from a validation dataset satisfy performance requirements. In this case, the equipment is also configured to, based on the trained machine learning model being invalid, analyze the training dataset and/or the trained machine learning model to determine what additional training data to add to the training dataset. In this case, the equipment is also configured to transmit signaling for configuring one or more autonomous or automated mobile devices served by the non-public communication network to help collect the additional training data. In this case, the equipment is also configured to re-train the machine learning model with the training dataset as supplemented with the additional training data.

In some embodiments, the equipment is configured to perform the steps described above for equipment supporting a non-public communication network.

Other embodiments herein include a computer program comprising instructions which, when executed by at least one processor of equipment configured to support a non-public communication network, causes the equipment to train a machine learning model with a training dataset to make a prediction or decision in the non-public communication network. The computer program in this regard causes the equipment to determine whether the trained machine learning model is valid or invalid based on whether predictions or decisions that the trained machine learning model makes from a validation dataset satisfy performance requirements. The computer program further causes the equipment to, based on the trained machine learning model being invalid, analyze the training dataset and/or the trained machine learning model to determine what additional training data to add to the training dataset. The computer program also causes the equipment to transmit signaling for configuring one or more autonomous or automated mobile devices served by the non-public communication network to help collect the additional training data. The computer program further causes the equipment to re-train the machine learning model with the training dataset as supplemented with the additional training data.

In some embodiments, a carrier containing the computer program is one of an electronic signal, optical signal, radio signal, or computer readable storage medium.

Other embodiments herein include equipment configured to support a non-public communication network, the equipment comprising processing circuitry. The processing circuitry is configured to train a machine learning model with a training dataset to make a prediction or decision in the non-public communication network. In this case, the processing circuitry is further configured to determine whether the trained machine learning model is valid or invalid based on whether predictions or decisions that the trained machine learning model makes from a validation dataset satisfy performance requirements. In this case, the processing circuitry is further configured to, based on the trained machine learning model being invalid, analyze the training dataset and/or the trained machine learning model to determine what additional training data to add to the training dataset. In this case, the processing circuitry is further configured to transmit signaling for configuring one or more autonomous or automated mobile devices served by the non-public communication network to help collect the additional training data. In this case, the processing circuitry is further configured to re-train the machine learning model with the training dataset as supplemented with the additional training data.

In some embodiments, the processing circuitry is configured to perform the steps described above for equipment supporting a non-public communication network.

Of course, the present disclosure is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of a non-public communication system in accordance with some embodiments.

FIG. 2A is a block diagram of heatmap(s) generated according to some embodiments herein.

FIG. 2B is a block diagram of score function(s) generated from the heatmap(s) in FIG. 2A.

FIG. 3A is a block diagram of some embodiments in which automated or autonomous mobile device(s) help to collect additional training data.

FIG. 3B is a block diagram of other embodiments in which automated or autonomous mobile device(s) help to collect additional training data.

FIG. 3C is a block diagram of yet other embodiments in which automated or autonomous mobile device(s) help to collect additional training data.

FIG. 3D is a block diagram of still other embodiments in which automated or autonomous mobile device(s) help to collect additional training data.

FIG. 4A is a block diagram of some embodiments in which automated or autonomous mobile device(s) help to collect additional training data from one or more locations in the coverage area of the non-public communication network.

FIG. 4B is a block diagram of some embodiments in which automated or autonomous mobile device(s) are re-routed to help to collect additional training data from one or more locations in the coverage area of the non-public communication network.

FIG. 5 is a logic flow diagram of training data enrichment according to some embodiments.

FIG. 6 is a logic flow diagram of data enrichment planning according to some embodiments.

FIG. 7 is a logic flow diagram for checking the safety of executing the data enrichment plan actions at execution time according to some embodiments.

FIG. 8 is a block diagram of system components for training data enrichment according to some embodiments.

FIG. 9 is a call flow diagram for training data enrichment according to some embodiments.

FIG. 10 is a logic flow diagram of a method for training data enrichment according to some embodiments.

FIG. 11 is a block diagram of equipment configured for training data enrichment according to some embodiments.

### DETAILED DESCRIPTION

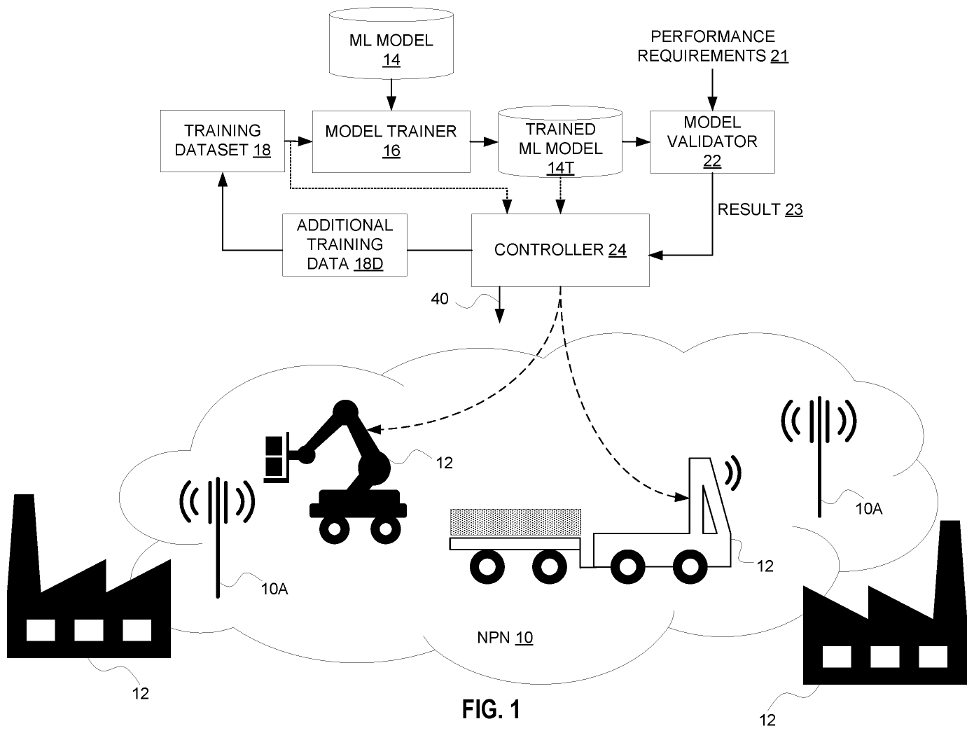

FIG. 1 shows a non-public communication network (NPN) 10 according to some embodiments. The non-public communication network 10 is a communication network intended for non-public use. The non-public communication network 10 may for example be a communication network that is at least partly private. The non-public communication network 10 may thereby have one or more parts in an isolated network deployment that do not interact with a public communication network. At least one or more parts of the non-public communication network 10 may for example be operated by a private network operator which only allows certain pre-registered devices to attach to it. In some embodiments, though, some network functionality may be provided by a public network operator. For example, some network functionality, such as radio access and/or the control plane, may be provided by a public network operator, e.g., as a service for the private network operator.

In some embodiments, the non-public communication network 10 is a so-called standalone NPN (SNPN). In one such embodiment, all functionality of the SNPN is provided by a private network operator. In another embodiment, all functionality of the SNPN except for radio access is provided by a private network operator, with radio access being provided by (e.g., shared with) a public network operator. In still other embodiments, the non-public communication network 10 is a public network integrated NPN (PNI-NPN). In this case, the non-public communication network is deployed with the support of a public communication network.

Regardless, FIG. 1 shows an example of a concrete use case where the non-public communication network 10 provides communication service over the geographic footprint of a factory or other industrial site 12. The non-public communication network 10 in such a case may communicatively connect industrial internet-of-things (IoT) equipment at the industrial site 12, such as robotic tooling, sensors, instruments, or any other industrial equipment, for the purpose of enhancing functional operations of the industrial site.

According to embodiments herein, the non-public communication network 10 also serves one or more autonomous or automated mobile devices 12. The autonomous or automated mobile device(s) 12 are device(s) capable of moving within the coverage area of the non-public communication network 10 in an automated or autonomous way. The autonomous or automated mobile device(s) 12 in this regard may include one or more autonomous mobile devices and/or one or more automated mobile devices.

Automated mobile devices for example include self-guided vehicles, laser-guided vehicles, automated guided carts, and/or any type of automated guided vehicle (AGV) capable of moving without an onboard operator or driver, e.g., for transporting materials or products around an industrial site. Automated mobile devices in these and other embodiments may rely on infrastructure, such as magnetic strips, tracks, wires, or visual markers, for automating movement and navigation.

Autonomous mobile devices by contrast include devices capable of understanding and moving through their environment independent of human oversight, in an autonomous way, e.g., without relying on infrastructure like tracks or wires for navigation. Autonomous mobile devices for example include autonomous mobile robots (AMRs). In some embodiments, AMRs use a sophisticated set of sensors, artificial intelligence, and/or path planning to interpret and navigate through their environment, untethered from wired power. AMRs in some instance may accordingly employ a navigation technique like collision avoidance to autonomously slow, stop, or reroute their path around an obstacle and then continue with their task.

As another example, automated or autonomous mobile device(s) 12 herein may include unmanned aerial vehicles (UAVs), commonly known as drones. UAVs are aircraft without any human pilot or crew. The flight of UAVs herein may operate with at least some automation (e.g., via autopilot assistance) or may operate with full autonomy.

At least some of the automated or autonomous mobile device(s) 12 may be configured to perform a functional task, e.g., in support of an industrial process. For example, an automated or autonomous mobile device 12 may be configured to transport materials, work-in-process, and/or finished goods in support of manufacturing product lines. As another example, an automated or autonomous mobile device 12 may be configured to store, inventory, and/or retrieve goods in support of industrial warehousing or distribution. As still another example, an automated or autonomous mobile device 12 may be configured to conduct safety and/or security checks, perform cleaning tasks for sanitization or trash removal, deliver food or medical supplies, etc.

In some embodiments, an automated or autonomous mobile device 12 is nominally configured to move along a route in support of performing one or more such functional tasks. In this case, the route along which an automated or autonomous mobile device 12 is nominally configured to move may be statically defined or may be dynamically adapted as needed to perform assigned functional task(s). In these and other embodiments, then, the automated or autonomous mobile device(s) 12 may be deployed primarily for the purpose of performing functional task(s), e.g., in support of an industrial process.

Embodiments herein exploit the automated or autonomous mobile device(s) 12 to help collect training data for training a machine learning model to make a prediction or decision in the non-public communication network 10. Some embodiments for example determine location(s) from which additional training data would be beneficial and re-route the automated or autonomous mobile device(s) 12 to the determined location(s) for training data collection. In fact, some embodiments iteratively train and evaluate the machine learning model in this way over multiple rounds of training, and employ the automated or autonomous mobile device(s) 12 to collect additional training data in between training rounds, as needed in order to ultimately validate the trained model as satisfying performance requirements. These and other embodiments thereby advantageously capitalize on the automated and/or autonomous nature of the served mobile device(s) 12 for training data enrichment, e.g., with no or little impact on the otherwise functional value of those served mobile device(s) 1. This enrichment may in turn support accurate and robust machine learning training in the non-public communication network 10, e.g., so that machine learning can prove effective for managing even a non-public communication network.

More particularly in this regard, FIG. 1 shows a machine learning model 14 according to some embodiments. The machine learning model 16 is a combination of model data stored in machine memory and a machine-implemented predictive algorithm configured to infer one or more output parameters, or “labels,” from one or more input data parameters, or “features.” The machine learning model 16 in this regard may be instantiation of a data structure comprising the model data coupled with an instantiation of the predictive algorithm.

FIG. 1 further shows a model trainer 16 configured to train the machine learning model 14 to make a prediction or decision in the non-public communication network 10. The prediction or decision may be, for example, a prediction of one or more Key Performance Indicators (KPIs) characterizing the non-public communication network's performance under one or more conditions, a decision about the root cause of a performance problem, a decision about whether an anomaly is present, or a decision about optimal network configuration parameters. Regardless of the nature of the prediction or decision, the model trainer 16 may train the machine learning model 14 to make that prediction or decision by adapting the model data and/or the predictive algorithm.

The model trainer 16 trains the machine learning model 14 in this way with a training dataset 18. The training dataset 18 may for example include performance management (PM) data and/or configuration management (CM) data for the non-public communication network 10, e.g., in the form of PM counters and/or PM events.

In one embodiment, the training dataset 18 includes labeled data for supervised learning. In this case, the training dataset 18 includes sets of input data parameter(s) (i.e., feature(s)) tagged with respective sets of one or more respective output data parameters (i.e., label(s)). Training the machine learning model 14 with such a training dataset 18 involves identifying which input data parameter(s) are associated with which output data parameter(s) according to the training dataset 18, and then configuring the model data and/or predictive algorithm of the machine learning model 14 to be able to infer the output data parameter(s) from the input data parameter(s) in unlabeled data.

In another embodiment, by contrast, the training dataset 18 includes unlabeled data for unsupervised learning. In this case, the training dataset 18 includes raw data or data that is not tagged with any labels. Training the machine learning model 14 with such a training dataset 18 involves finding patterns in the unlabeled data so as to identify feature(s) to serve as input data feature(s), and then configuring the model data and/or predictive algorithm of the machine learning model 14 to be able to infer the output data parameter(s) from the input data parameter(s) in unlabeled data.

No matter whether the training dataset 18 supports supervised or unsupervised learning, training of the machine learning model 14 with the training dataset 18 produces a trained machine learning model 14T. FIG. 1 shows that a model validator 22 determines whether this trained machine learning model 14T is valid or invalid, e.g., with validity or invalidity of the trained machine learning model 14T being indicated as a result 23 output by the model validator 22. The model validator 22 may for instance determine whether predictions or decisions that the trained machine learning model 14T makes from a validation dataset (not shown) satisfy performance requirements 21. As just one example, the performance requirements 21 may require that the trained machine learning model 14T make predictions or decisions from the validation dataset with at least a minimum level of accuracy, e.g., 97% accuracy, in order to be deemed valid.

Invalidity of the trained machine learning model 14T may be attributable to a deficiency of the training dataset 18. The training dataset 18 may for example lack sufficient training data for one or more machine learning features, i.e., the training dataset 18 does not discover the feature state space well enough. Alternatively or additionally, the training dataset 18 may lack sufficient training data in terms of a number of, and/or a diversity of, values for one or more machine learning features. For these and/or other reasons, then, the trained machine learning model 14T may not be as accurate and/or as robust as required due to some deficiency of the training dataset 18.

Some embodiments herein address invalidity of the trained machine learning model 14T by supplementing the training dataset 18 with additional training data 18D. FIG. 1 in this regard shows that the model validator 22 provides the result 23 of its model validation to a controller 24. Based on the result 23 indicating that the trained machine learning model 14T is invalid, the controller 24 determines what additional training data 18D to add to the training dataset 18. The controller 24 may for instance analyze the training dataset 18 and/or the trained machine learning model 14T in order to determine what additional training data 18D to add to the training dataset 18. Such analysis may reveal or at least suggest what additional training data 18D will mitigate some deficiency of the training dataset 18 so as to effectively enrich the training dataset 18 and encourage satisfaction of the performance requirements 21. Regardless, after collection of the additional training data 18D, the controller 24 adds the additional training data 18D to the training dataset 18.

The model trainer 16 thereafter re-trains the machine learning model 14 with the training dataset 18 as supplemented with the additional training data 18D. This re-training again results in a trained machine learning model 14T, which is then re-validated by the model validator 22. If the addition of the additional training data 18D to the training dataset 18 remedied some deficiency that contributed to invalidity of the previously trained machine learning model, the newly trained machine learning model 14T may now satisfy the performance requirements 21 and be deemed valid. Otherwise, if there still remains some deficiency in the training dataset 18 so that the newly trained machine learning model 14T is still invalid, the controller 24 in some embodiments may again supplement the training dataset 18 with additional training data 18D. Generally, then, some embodiments iteratively train and evaluate the validity of the machine learning model 14 in this way over multiple rounds of training, supplementing the training dataset 18 with additional training data 18D in between training rounds, as needed in order to ultimately validate the trained machine learning model 14T as satisfying the performance requirements 21. After the trained machine learning model 14T is validated, the trained machine learning model 14T may be used for any number of purposes in the non-public communication network 10, e.g., for root-cause analysis, anomaly detection, network optimization, etc.

Intelligent selection of what additional training data 18D to add to the training dataset 18 impacts how well and/or how efficiently re-training of the machine learning model 14 works towards satisfying the performance requirements 21 for the trained machine learning model 14T. Towards this end, the controller 24 may govern what additional training data 18D to add in terms of how much and/or what kind of additional training data 18D to add to the training dataset 18. Alternatively or additionally, the controller 24 may dictate what additional training data 18D to add by dictating how the additional training data 18D is collected, e.g., from what and/or where the additional training data 18D is collected.

The controller 24 may for example determine to add additional training data 18D for one or more machine learning features which are not well represented in the existing training dataset 18. In one such embodiment, the controller 24 may analyze how impactful different machine learning features represented by the training dataset 18 are to the prediction or decision. The controller 24 may then select one or more machine learning features for which to collect additional training data 18D, based on how impactful the one or more machine learning features are to the prediction or decision. The controller 24 may for instance select to collect additional training data 18D for machine learning feature(s) that are most impactful to the prediction or decision.

As another example, the controller 24 may determine to add additional training data 18D for one or more machine learning features that lack a sufficient number of, and/or diversity of, values in the existing training dataset 18. In one such embodiment, the controller 24 may, for each of one or more machine learning features represented by the training dataset 18, analyze a number of and/or a diversity of values in the training dataset 18 for the machine learning feature, and select one or more machine learning features for which to collect additional training data 18D, based on that number and/or diversity. The controller 24 may for instance select to collect additional training data 18D for machine learning feature(s) that have less than a threshold number of values in the training dataset 18 and/or that have less than a threshold level of value diversity in the training dataset 18.

As still another example, the controller 24 may alternatively or additionally determine one or more locations, in the coverage area of the non-public communication network 10, at which to collect the additional training data 18D. Different locations in the network's coverage area may for example be conducive to the collection of different types of training data, e.g., training data for different machine learning features or training data for different values of a certain machine learning feature. In order to collect training data representing high values for network load as a machine learning feature, for instance, some locations in the network's coverage area may experience higher network load than others, e.g., locations with higher device density. In these and other embodiments, then, the controller 24 may determine one or more machine learning features for which to collect additional training data and then identify location(s) at which to collect the additional training data for those machine learning feature(s).

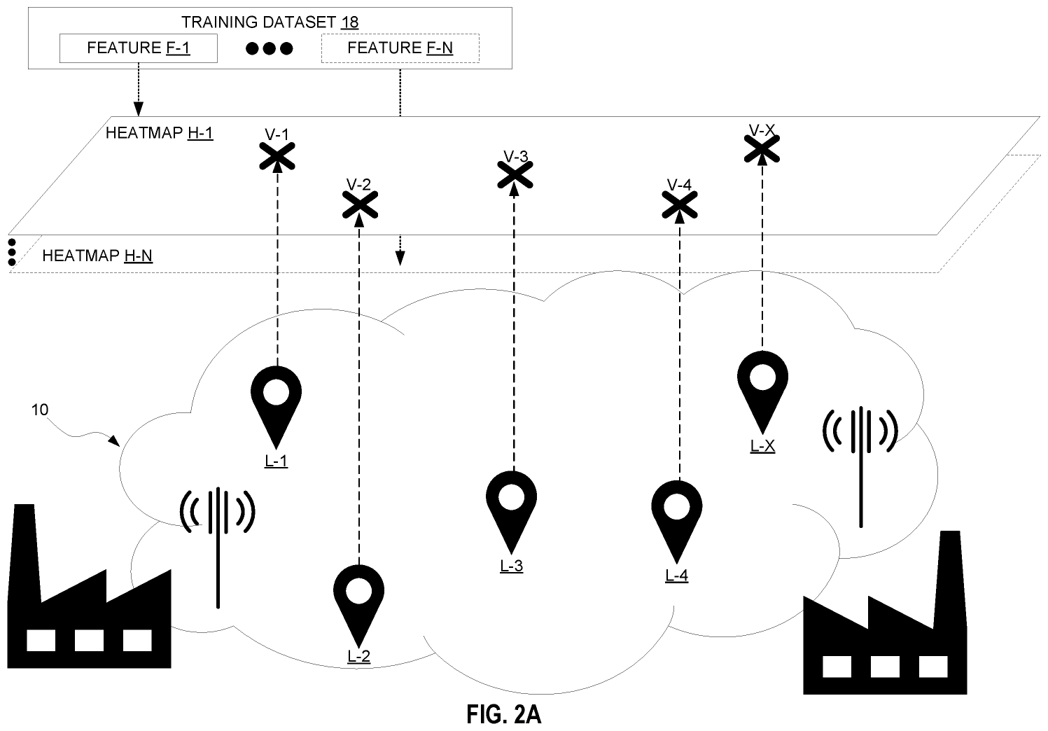

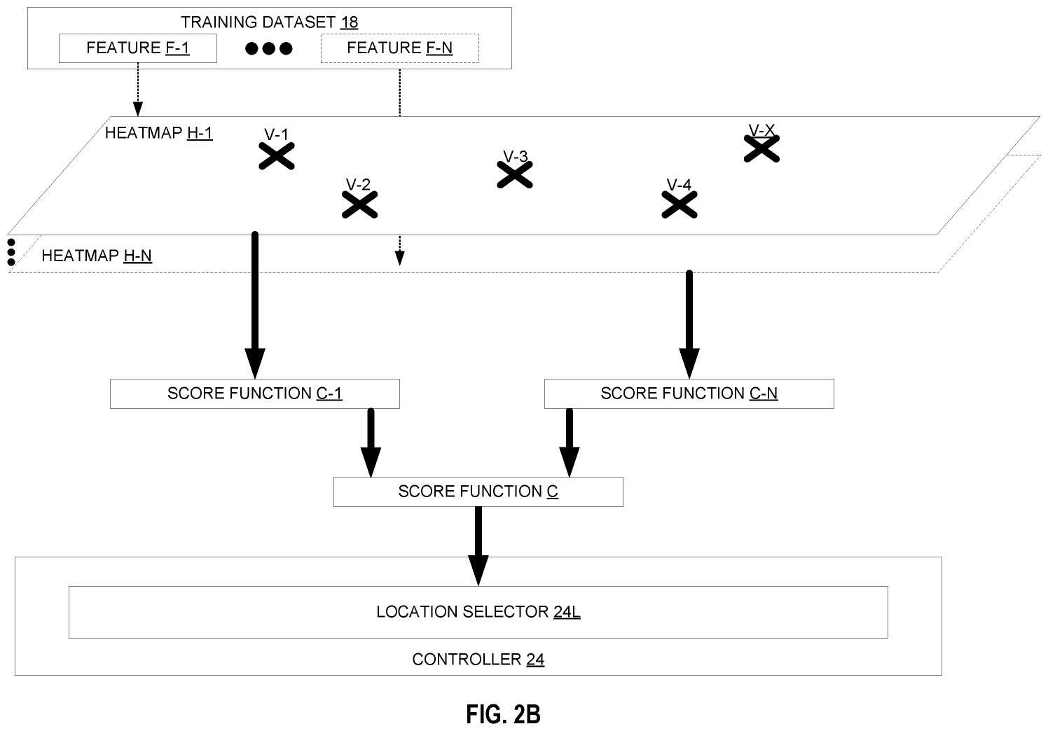

In some embodiments in this regard, the controller 24 quantifies the benefit of collecting additional training data 18D from different locations by giving each location a score, e.g., with a higher score indicating greater benefit. The controller 24 then selects location(s) at which to collect additional training data 18D based on the locations' respective scores, e.g., by selecting location(s) with the highest score(s). FIGS. 2A-2B illustrate one or more such embodiments.

As shown in FIG. 2A, the training dataset 18 includes training data for N machine learning features F-1 . . . F-N, e.g., network load, network coverage, and/or interference. The controller 24 correspondingly generates a so-called heatmap for each of the N machine learning features F-1 . . . F-N, resulting in N heatmaps H-1 . . . H-N for the N respective features. Heatmap H-1 as shown represents X values V-1 . . . V-X of machine learning feature F-1 at X different locations L-1 . . . L-X in the network's coverage area. The value of the machine learning feature F-1 represented in the heatmap H-1 for any given location may for instance statistically represent the value of the machine learning feature F-1 at that location, e.g., as a time-averaged average value of the machine learning feature F1 at the location. Where the machine learning feature F-1 is network load, for example, value V-2 in heatmap H-1 may represent the average network load at location L-2. Regardless, in some embodiments, the controller 24 generates the heatmap(s) H-1 . . . H-N from measurements of the machine learning features F-1 . . . F-N, e.g., as reported by served devices in the non-public communication network 10 along with the locations of the reported measurements.

Based on the heatmap(s) H-1 . . . H-N, the controller 24 as shown in FIG. 2B generates score function(s) C-1 . . . C-N for the machine learning feature(s) F-1 . . . F-N. The score function for a machine learning feature represents scores for respective locations in the network's coverage area, with the score for a location quantifying the benefit of collecting additional training data 18D for the machine learning feature at the location. In the example of FIG. 2B, then, the score function C-1 for machine learning feature F-1 represents scores S-1 . . . S-X for respective locations L-1 . . . L-X in the network's coverage area. Score S-1 for location L-1 quantifies the benefit of collecting additional training data 18D for machine learning feature F-1 at location L-1. Score S-2 for location L-2 quantifies the benefit of collecting additional training data 18D for machine learning feature F-1 at location L-2. And so on.

In some embodiments, the score function for a machine learning feature represents the score for a location as a function of a number of and/or a diversity of values in the training dataset 18 for the machine learning feature at the location. The lower the number of values in the training dataset 18 for a machine learning feature at the location and/or the smaller the diversity of values in the training dataset 18 for the machine learning feature at the location, the larger the benefit of collecting additional training data 18D for that machine learning feature at the location and thus the greater the score for the location. Alternatively or additionally, the score function for a machine learning feature represents the score for a location as a function of an accuracy of the machine learning model at a location. The lower the accuracy of the machine learning model at a location, the larger the benefit of collecting additional training data 18D for that machine learning feature at the location and thus the greater the score for the location. Alternatively or additionally, the score function for a machine learning feature represents the score for a location as a function of an uncertainty of the machine learning model at the location. The higher the uncertainty of the machine learning model at a location, the larger the benefit of collecting additional training data 18D for that machine learning feature at the location and thus the greater the score for the location.

No matter the particular details of the score function for a machine learning feature, the controller 24 as shown determines a single score function C that generally quantizes the benefit of collecting additional training data 18D at location(s) in the network's coverage area. If the controller 24 has generated a single score function C-1 for a single machine learning feature (i.e., N=1), the controller 24 may use that score function C-1 itself as the single score function C. If the controller 24 generates score functions C-1 . . . C-N for multiple respective machine learning features, by contrast, the controller 24 may determine the single score function C as being a combination of the score functions C-1 . . . C-N for the machine learning features, e.g., as being a sum, straight average, or weighted average of the score functions C-1 . . . C-N for the machine learning features. The controller 24 as shown then uses the single score function C in order to select location(s) at which to collect additional training data 18D. For example, the controller 24 may select to collect additional training data 18D from all location(s) that have a score greater than a threshold score. Or, as another example, the controller 24 may select to collect additional training data 18D from a certain number of location(s) having the greatest score.

As these examples demonstrate, then, the controller 24 in some embodiments controls what additional training data 18D to add in terms of what kind of additional training data 18D to add and/or from where the additional training data 18D is collected.

Regardless of the particular nature of the additional training data 18D, the controller 24 according to some embodiments herein notably controls automated or autonomous mobile device(s) 12 served by the non-public communication network 10 to help collect this additional training data 18D. The controller 24 in this regard may control the automated or autonomous mobile device(s) 12 to perform certain action(s), with the effect of the action(s) being that the action(s) facilitate or contribute in some way to the collection of the additional training data 18D. Accordingly, action(s) performed by automated or autonomous mobile device(s) 12 help to collect the additional training data 18D as long as the action(s) facilitate or contribute in some way to the collection of the additional training data 18D, even if the automated or autonomous mobile device(s) lack knowledge that the action(s) help to collect the additional training data 18D and even if the automated or autonomous mobile device(s) 12 do not themselves collect the additional training data 18D.

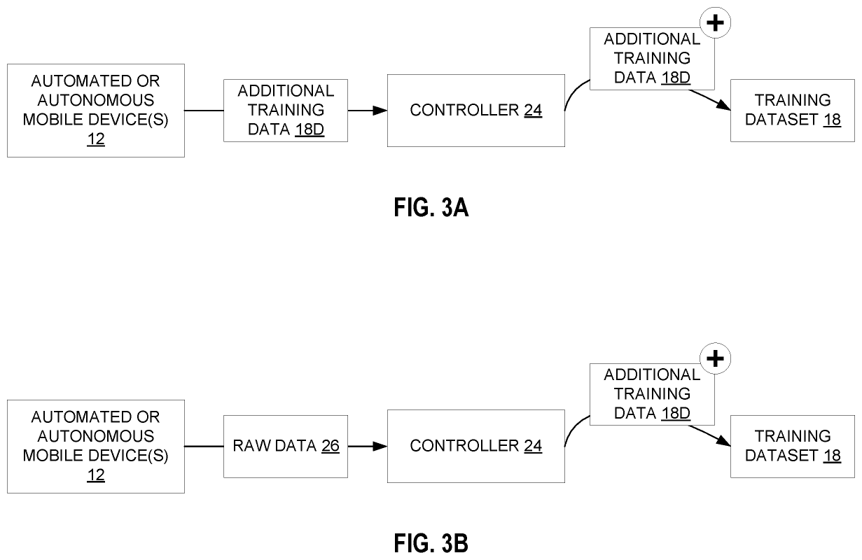

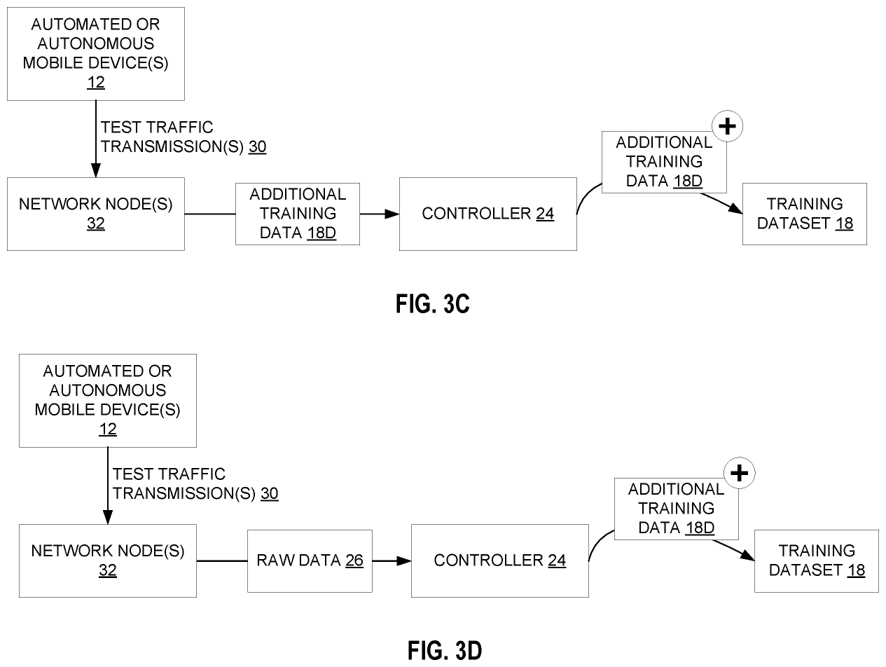

FIGS. 3A-3D illustrate some examples of action(s) by the automated or autonomous mobile device(s) 12 that help collect the additional training data 18D. As shown in FIG. 3A, the controller 24 controls the automated or autonomous mobile device(s) 12 to perform action(s) that include actually collecting the additional training data 18D and reporting the additional training data 18D to the controller 24. The controller 24 in turn adds the additional training data 18D to the training dataset 18.

FIG. 3B illustrates a different example in which the controller 24 controls the automated or autonomous mobile device(s) 12 to perform action(s) that include reporting raw data 26 to the controller 24. The raw data 26 may for instance be the results of one or more measurements performed by the automated or autonomous mobile device(s) 12, in which case the action(s) may include performing the measurement(s) and reporting the results of the measurement(s). Regardless, the controller 24 in this example forms, determines, or otherwise collects the additional training data 18D based on the reported raw data 26. The controller 24 may for example label the raw data 26 to produce the additional training data 18D as labeled data.

In case the raw data 26 includes the results of one or more measurements performed by the automated or autonomous mobile device(s) 12, the measurement(s) may be passive or active in nature. Passive measurements are performed in a non-intrusive way that does not impact any ongoing traffic in the non-public communication network 10. Passive measurements may for instance be performed on signals, channels, and/or traffic that would have been transmitted anyway, even without collection of additional training data 18D. Active measurements by contrast are performed in an intrusive way that has at least some impact on any ongoing traffic in the non-public communication network 10. Active measurements may for instance be performed on signals, channels, and/or traffic that is transmitted only for the purpose of additional training data collection. Traffic transmitted only for the purpose of additional training data collection may be referred to as test traffic, e.g., which may take the form of dummy traffic.

In contrast to FIGS. 3A and 3B, FIG. 3C illustrates an example in which the controller 24 controls the automated or autonomous mobile device(s) 12 to perform action(s) that include performing one or more transmissions 30 of test traffic to one or more network nodes 32 in the non-public communication network 10. The test traffic transmission(s) 30 may support active measurement(s) that are performed on and/or during the test traffic transmission(s) 30, with the additional training data 18D being collected based on the results of such active measurement(s). In this case, the active measurement(s) may be performed by at least some of the automated or autonomous mobile device(s) 12 and/or network node(s) 32 in the non-public communication network 10. Regardless, in some embodiments, the test traffic transmission(s) 30 contribute to the traffic load in the non-public communication network 10, in order for the additional training data 18D collected to be representative of certain loading conditions. In FIG. 3C's example, the network node(s) 32 collect the additional training data 18D based on the test traffic transmission(s) 30 and report the additional training data 18D to the controller 24. The controller 24 then adds the additional training data 18D to the training dataset 18.

FIG. 3D by comparison illustrates an example similar to FIG. 3C, except the network node(s) 32 report raw data 26 to the controller 26 rather than reporting the additional training data 18D directly. The network node(s) 32 may for instance perform active measurement(s) on the test traffic transmission(s) 30 and simply report the results of the active measurement(s) to the controller 24 as the raw data 26. In these and other embodiments, the controller 24 collects the additional training data 18D based on the reported raw data 26. The controller 24 may for example label the raw data 26 to produce the additional training data 18D as labeled data.

As these examples demonstrate, then, whether automated or autonomous mobile device(s) 12 collect the additional training data 18D themselves, report raw data 26 based on which the additional training data 18D is collected, perform test traffic transmission(s) 30 based on which the additional training data 18D is collected, or perform some other action(s) that facilitate or contribute in some way to the collection of the additional training data 18D, the automated or autonomous mobile device(s) 12 help collect the additional training data 18D.

In some embodiments, the controller 24 controls automated or autonomous mobile device(s) 12 to help collect additional training data 18D from certain location(s), e.g., selected according to the example in FIGS. 2A-2B. The controller 24 in one such embodiment may control automated or autonomous mobile device(s) 12 to travel to the certain location(s). The controller 24 may further control the automated or autonomous mobile device(s) 12 to perform test traffic transmission(s) at the certain location(s) and/or to report measurement(s) that are performed while the automated or autonomous mobile device(s) are at the certain location(s), so as to contribute to collecting training data from those certain location(s).

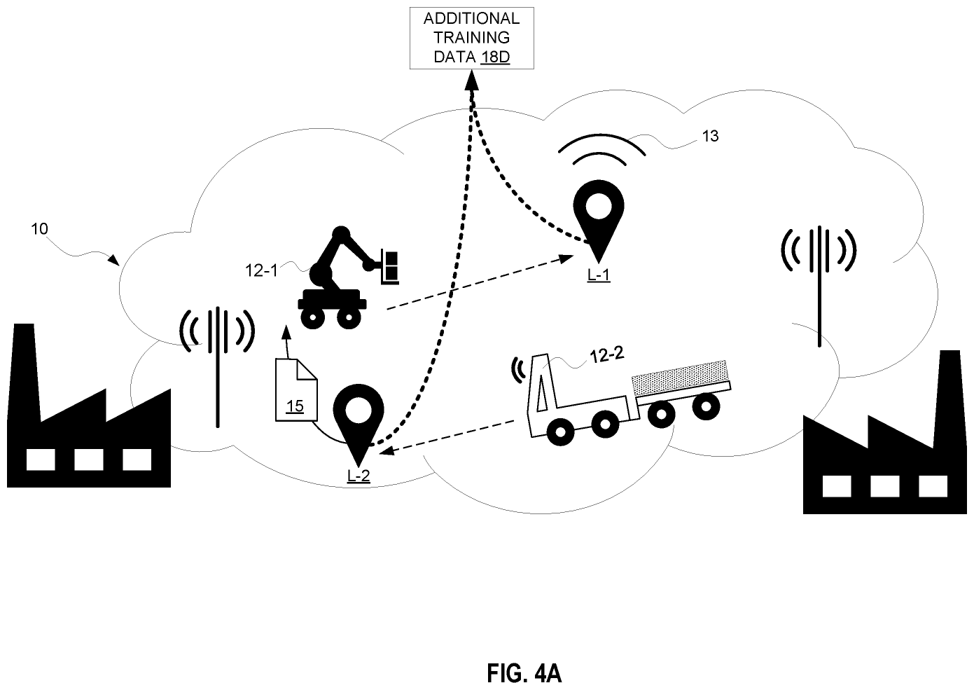

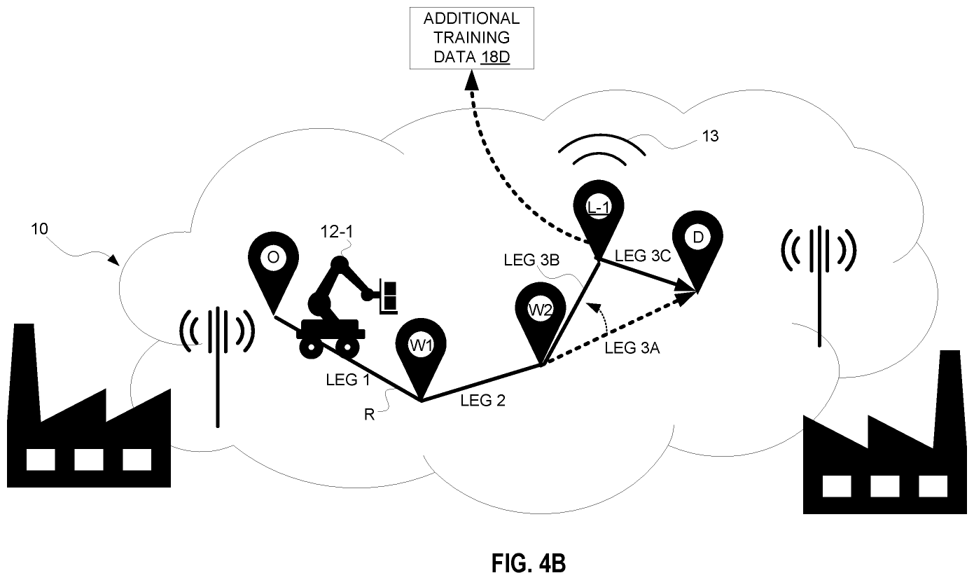

In the example of FIG. 4A, for instance, the controller 24 controls automated or autonomous mobile device 12-1 to travel to location L-1 to help with training data collection from that location L-1, e.g., by performing test traffic transmission(s) 13 at location L-1. The controller 24 also controls automated or autonomous mobile device 12-2 to travel to location L-2 to help with training data collection from that location L-2, e.g., by providing report(s) 15 of measurement(s) performed at the location L-2.

Note that, in some embodiments, the controller 24 controls an automated or autonomous mobile device 12 to help with training data collection from a certain location, by routing the automated or autonomous mobile device 12 to or through that certain location. If for instance the device is nominally configured to travel along an existing route as part of performing a functional task, the controller 24 may revise that route to include the certain location as a destination or waypoint in the route. Such route revision however may be subject to a constraint that there is enough tolerance in the route and/or functional task requirements so that revision of the route to include the certain location does not jeopardize performance requirements for the functional task. Generally, then, the controller 24 may take into account any other constraints on the route, e.g., needed for the automated or autonomous mobile device(s) 12 to complete a functional task according to performance requirements for that task.

In the example of FIG. 4B, for instance, automated or autonomous mobile device 12-1 is nominally configured to travel along a production route R from an origin O to a destination D. The device 12-1 does so as part of performing an industrial task that includes transporting material from the origin O to the destination D within a threshold amount of time T. The production route R in this example includes waypoints W1 and W2, such that the device 12-1 travels from the origin O to waypoint W1 along Leg 1, from waypoint W1 to waypoint W2 along Leg 2, and from waypoint W2 to the destination D along Leg 3A. There is enough tolerance in the production route R that the device 12-1 only ever takes a small amount of time T1 to traverse the production route R, meaning that there is some allowance for deviation from the production route R. The controller 24 accordingly revises the device's production route R as part of controlling the device 12-1 to help with training data collection from location L-1. The controller 24 in particular revises the production route R to include location L-1 as an additional waypoint between waypoint W2 and the destination D. As shown, then, the controller 24 replaces Leg 3A with Legs 3B and 3C, such that the controller 24 now travels from the original O to waypoint W1 along Leg 1, travels from waypoint W1 to waypoint W2 along Leg 2, travels from waypoint W2 to the location L-1 along Leg 3B, helps with training data collection at location L-1, and then travels from location L-1 to the destination D along Leg 3C. Adding the location L-1 as a waypoint in the production route R delays the device 12-1 and causes the device 12-1 to take a larger amount of time T2 to traverse the production route R, but the device 12-1 is still able to complete the production route R within the threshold amount of time T, i.e., T2<T.

Extrapolated from this simplified example, though, the controller 24 may determine the route(s) for the automated or autonomous mobile device(s) 12 as part of an overall data collection plan for collecting the additional training data 18D. In some embodiments, for instance, the controller 24 solves an optimization problem that optimizes a data collection plan for each of the autonomous or automated mobile device(s) 12. In this case, the data collection plan for an autonomous or automated mobile device 12 includes a plan on what training data the autonomous or automated mobile device 12 will help collect and what route the autonomous or automated mobile device 12 will take as part of helping to collect that training data.

In one such embodiment, though, optimization of the data collection plan for each of the automated or autonomous mobile device(s) 12 is subject to one or more constraints. The one or more constraints may for example include a constraint on movement dynamics of each of the autonomous or automated mobile device(s) 12. Here, the movement dynamics of an autonomous or automated mobile device 12 constrains the range of motion that the device is physically able to achieve, e.g., the type of wheels that the device 12 has may constrain the device to only being able to move back and forth along a straight line, without turning.

Alternatively or additionally, the one or more constraints may include a constraint on allowed deviation from a production route of each of the autonomous or automated mobile device(s) 12. The allowed deviation may for instance be dictated by how much tolerance a device's production route provides for the device to meet performance requirements for a functional task. For example, if the production route gives a device a tolerance of 30 seconds delay in reaching the destination, a deviation from the production route that delays the device reaching the destination for up to 30 seconds is allowed.

The one or more constraints may alternatively or additionally include a constraint on an extent to which collection of additional training data 18D is allowed to disturb the non-public communication network 10. For example, there may be a constraint on when and/or where active measurements can be performed as part of training data collection.

Regardless, in embodiments where the controller 24 generates a score function C as described in FIGS. 2A-2B, the controller 24 may solve the optimization problem by maximizing the score function over a planning time horizon, e.g., subject to the constraint(s).

Note that in some embodiments the controller 24 may solve the optimization problem for each automated or autonomous mobile device 12 individually. In other embodiments, though, the controller 24 jointly solves the optimization problems for multiple automated or autonomous mobile devices 12 so that, collectively, the routes taken by the multiple automated or autonomous mobile devices 12 are optimal.

Irrespective of whether the controller 24 controls from where the additional training data 18D is collected, in some embodiments, the controller 24 controls the automated or autonomous mobile device(s) 12 to help collect the additional training data 18D, by triggering, causing, executing, or otherwise controlling configuration of the automated or autonomous mobile device(s) 12. The configuration of the automated or autonomous mobile device(s) 12 may for example concern the configuration of whether, how, when, and/or where to directly collect the additional training data 18D, measure and report raw data 26, perform test traffic transmission(s) 30, and/or perform other action(s) that facilitate or contribute to the collection of the additional training data 18D. So configured, the automated or autonomous mobile device(s) 12 help collect the additional training data 18D.

Referring briefly back to FIG. 1, the controller 24 in one such embodiment transmits signaling 40 for configuring the automated or autonomous mobile device(s) 12 to help collect the additional training data 18D. In embodiments where the controller 24 itself executes configuration of the automated or autonomous mobile device(s) 12 to help collect the additional training data 18D, this signaling 40 may be configuration signaling that actually configures the automated or autonomous mobile device(s) 12 to help collect the additional training data 18D, e.g., the signaling 40 indicates how the automated or autonomous mobile device(s) 12 are to be configured. The controller 24 in this case may transmit such configuration signaling directly or indirectly to the automated or autonomous mobile device(s) 12 to help collect the additional training data 18D.

In other embodiments, by contrast, where the controller 24 triggers, causes, or controls configuration of the automated or autonomous mobile device(s) 12 to help collect the additional training data 18D, the signaling 40 may dictate, impact, or otherwise influence the configuration of the automated or autonomous mobile device(s) 12 in such a way that the automated or autonomous mobile device(s) 12 help collect the additional training data 18D. As one example, the signaling 40 may just indicate to another network node (not shown) what additional training data 18D is to be collected, e.g., in terms of the type of the additional training data 18D to be collected and/or location(s) from which the additional training data 18D is to be collected. The other network node in this case makes the decision about how the automated or autonomous mobile device(s) 12 are to be configured to help collect the indicated additional training data 18D.

As another example, the signaling 40 may indicate to another network node (not shown) action(s) that the automated or autonomous mobile device(s) 12 are to perform, and the other network node makes the decision about how the automated or autonomous mobile device(s) 12 are to be configured in order to perform the action(s), with the impact being that the action(s) help collect the additional training data 18D. In one specific example, the signaled action(s) may include performing one or more transmissions 30 of test traffic and/or performing and reporting the results of one or more measurements.

In another specific example, the signaled action(s) may include traveling to specified location(s) and performing active or passive measurement(s) at the specified location(s), in which case the signaling 40 may indicate the specified location(s), e.g., as part of indicating specified route(s) that the automated or autonomous mobile devices 12 are or are requested to take, consistent with the example in FIGS. 4A-4B. The other network node in this specific example may decide the route(s) with which to configure the automated or autonomous mobile device(s) 12, taking into account the location(s) or route(s) indicated by the signaling 40 for training data collection and taking into account any other constraints on the route(s), e.g., route(s) needed for the automated or autonomous mobile device(s) 12 to complete functional tasks.

Generally, then, in some embodiments, the signaling 40 includes signaling for configuring the autonomous or automated mobile device(s) 12 to help collect the additional training data 18D at one or more certain locations. In one such embodiment, the signaling 40 may include, for each of at least one of the autonomous or automated mobile device(s) 12, signaling for routing the autonomous or automated mobile device 12 to at least one location to help collect at least some of the additional training data 18D. The signaling 40 in this case may effectively revise a route of the autonomous or automated mobile device 12 to include the at least one location as a destination or waypoint in the route. The signaling 40 in these and other embodiments may indicate route(s) for the autonomous or automated mobile device(s) 12.

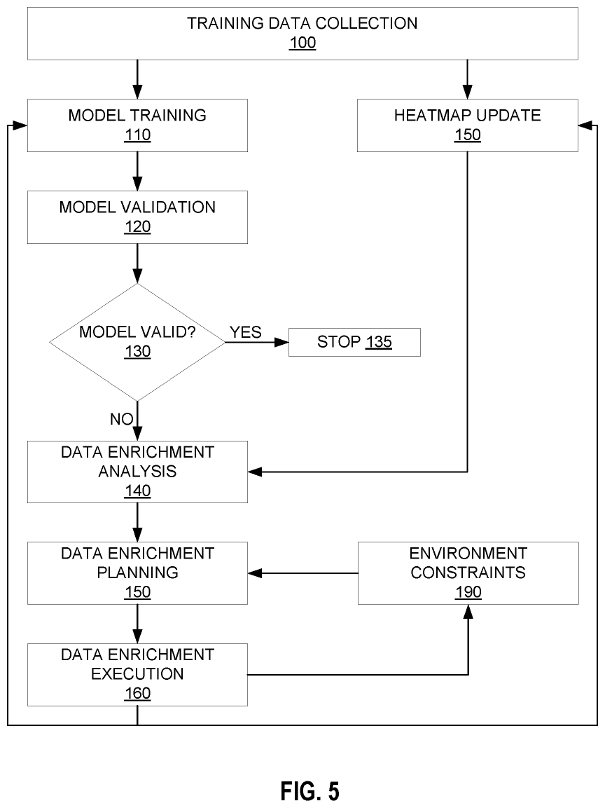

Consider now an example of some embodiments herein for a procedure for machine learning training as shown in FIG. 5. As shown, the machine learning training procedure involves training data collection, e.g., for initial generation of the training dataset 18 (Block 100). Such training data collection may include node level as well as mobile terminal level logs and measurements. The training data collected may include Performance Management (PM) data and/or Configuration Management (CM) data from a radio access network, transport network, and/or core network of the non-public communication network 10. In some embodiments, mobile devices send measurement reports to access points of the non-public communication network 10. In one such embodiment, an Operation and Support System (OSS) for the non-public communication network 10 collects these measurement reports into the training dataset 18, e.g., by labeling the measurement reports.

After generation of the training dataset 18, the machine learning training procedure further includes model training (Block 110). Model training here includes training the machine learning model 14 with the generated training dataset 18. The machine learning model 14 may for instance be trained to predict certain KPIs (e.g., latency and/or throughput) from low-level metrics (e.g., signal strength, interference, and/or cell load).

After model training, the machine learning training procedure further includes model validation (Block 120). Validation of the trained machine learning model 14T may mean validating that the trained machine learning model 14T meets accuracy requirements and/or robustness requirements. Here, accuracy refers to the ability of the trained machine learning model 14T to make a decision or prediction accurately, whereas robustness refers to the ability of the trained machine learning model 14T to make a prediction or decision from a wide range of values for its input data parameter(s) and/or to make a prediction or decision with a wide range of values. In some embodiments, for example, the model is considered to be valid if it is able to make predictions with high reliability for a diverse constellation of feature values.

The procedure next includes checking whether the trained machine learning model 14T is valid (Block 130). If the trained machine learning model 14T is valid (YES at Block 130), the procedure is stopped (Block 135). Otherwise, if the trained machine learning model 14T is not valid (NO at Block 130), then the procedure includes further steps to improve the trained machine learning model 14T.

Although not shown, in some embodiments, steps to improve the trained machine learning model 14T may include feature engineering, hyperparameter optimization, auto-ML methods, meta learning, etc. If the trained machine learning model 14T is validated after these improvement steps, the procedure may be stopped. However, if the trained machine learning model 14T is still not valid after these improvement steps, then the next step is to improve the quality of the training dataset 18.

The procedure in this case includes data enrichment analysis (Block 140). Data enrichment analysis determines which type of additional training data 18D should be collected.

To support data enrichment analysis, the procedure includes updating heatmap(s), e.g., heatmap(s) H-1 . . . H-N described in FIGS. 2A-2B (Block 150). In some embodiments, heatmap update involves the automated or autonomous mobile device(s) 12 measuring and reporting radio characteristics along with their location, contributing to a high-resolution heatmap of one or more PM parameters in the non-public communication network's access network. One or more heatmaps can be created from the measurement statistics, e.g., a heatmap for network load, a heatmap for network coverage, a heatmap for interference, etc.

With the heatmap(s) updated, training data is considered to be good quality in some embodiments if (i) various feature values appear; (ii) a considerable number of measurements are collected even in the rare cases; and (iii) the predicted KPIs are not critically out of balance. In case of very unbalanced KPI values, for instance, a collection of a considerable number of new measurements is needed. Good quality training data enables discovery of a broader subspace of the feature space, and this implies a better and more robust trained machine learning model 14T. In order to discover what is good quality data, the following steps are performed in some embodiments.

First, data enrichment analysis involves determining for which machine learning features (in the feature space) to collect additional training data. According to one embodiment, the features are ordered by their impact on the decision or prediction, e.g., of KPIs. Feature ordering may for instance be accomplished with the help of explain ability methods like Shapley Additive exPlanations (SHAP). With the aim of data collection being to vary the high-impact features, the features may be ordered from greatest impact to least impact and determining to collect additional training data for one or more of the features with the greatest impact, e.g., a fixed number of features with the greatest impact or any features having an impact greater than a threshold. As one example, if the feature of highest impact is the cell load, then data enrichment analysis may conclude to collect additional training data to represent a broad range of cell load, e.g., by collecting a broad range of cell load measurements.

After determining for which features to collect additional training data 18D, data enrichment analysis involves building a score function R(x, a): [symbol] ²× [symbol] → [symbol] that assigns a value to each pair of heatmap location x, action a. In some embodiments, this score function exemplifies the score function C in FIG. 2B. A high score at a location with a given action indicates the need for (or benefit of) additional data of the location and the action combination. For example, if high load occurs at location x, then the score of moving an automated or autonomous mobile device 12 to location x and measuring load is high. The score function is an output of the data enrichment analysis part. In some embodiments, the score function may be a function of (i) frequency or amount of training data collected at a location, (ii) the accuracy of the trained machine learning model 14T at that location, and/or (iii) the model uncertainty at that location. The higher the frequency and/or the higher the accuracy, the lower the score. The higher the model uncertainty, the higher the score.

In some embodiments, SHAP values for the machine learning features may be used directly to revisit locations with the highest importance. More particularly in this regard, the absolute value of SHAP for a feature indicates how important that feature is to the decision or prediction by the machine learning model 14. If a SHAP value for a feature is near zero, it means the feature is not important, i.e., it has no or little impact on the decision or prediction by the machine learning model 14. Some embodiments thereby drive the collection of additional training data 18 with SHAP values seen at different locations. Some embodiments accordingly use the SHAP value(s) for the feature(s) to construct the score function C. In this case, the location(s) in the heatmap(s) where information is collected about an important feature are assigned a score given by the SHAP value associated to that feature.

Note that, in some embodiments, whenever the heatmap(s) are updated, the data enrichment analysis would produce new score function(s) from the updated heatmap(s).

After it is determined what type of additional training data 18D to collect, the procedure includes determining how to collect the that type of additional training data 18D. This step is termed data enrichment planning (Block 150). Given the type of additional training data 18D that should be collected, a planning algorithm is used to instruct the automated or autonomous mobile device(s) 12 how to perform the data collection. The planning algorithm is an optimization algorithm that considers both the objective to maximize and the constraints to satisfy.

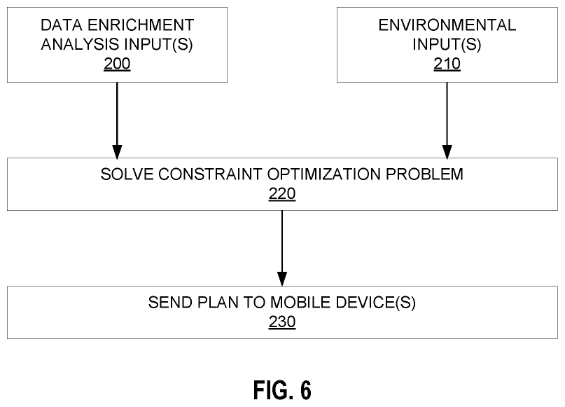

FIG. 6 shows one example of the planning algorithm which involves solving an optimization problem. As shown, the output(s) from the data enrichment analysis (e.g., the score function(s) R(x, a)) are provided as input(s) to the optimization problem (Block 200). Environmental input(s) are also provided as input(s) to the optimization problem, e.g., in the form of initial device states, the planning horizon, device movement dynamics, re-routing constraint levels, and/or network disturbance constraint level (Block 210). With the data enrichment analysis input(s) and the environmental input(s), the constraint optimization problem is solved (Block 220).

More particularly, the planning algorithm takes as input the current location and past and future trajectories of the automated or autonomous mobile device(s) 12. With that knowledge, the planning algorithm enforces three constraints (Block 190). As a first constraint, a mobile device must follow specific dynamics, e.g., depending on the type of the device and the environment. This first constraint may be based on an accurate physical model of the mobile device or based on a requirement that the mobile device must follow certain checkpoints (e.g., depending on the mobile device and the type of device position information available).

As a second constraint, re-routing of a mobile device is constrained to allow only limited re-routing. The constraint on re-routing can be device-specific and/or can take into account the wear and tear that re-routing would cause on the system.

As a third constraint, network disturbance is constrained. Active measurements might not be allowed at certain locations or at certain times.

With this formulation, the optimization problem in some embodiments is able to enforce that a mobile device cannot be re-routed from its current plan but rather may be instructed to only perform “opportunistic actions”, that is the mobile device only takes measurements once it visits the desired location when the production plan instructs it.

When the constraints are satisfied, the data collection will be turned on in location(s) with a high score. The score function is given by the data enrichment analysis step, where the score function exemplifies the score function(s) C-1 . . . C-X in FIG. 2B.

For a single autonomous or automated mobile device 12, for example, the planning algorithm in some embodiments solves:

$${max}_{\{ {a}_{τ} , … , {a}_{τ + H} \}} {\sum }_{t = τ . . τ + H} R ( {x}_{t} , {a}_{t} )$$

$$s . t$$

$${x}_{t + 1} = f ( {x}_{t} , {a}_{t} ) ( dynamics constraints in environment )$$

$$\vert {x}_{t} - {\hat{x}}_{t} \vert \leq δ ( limit rerouting , set to 0 to prevent )$$

$$\vert N ( {x}_{t} , {a}_{t} ) - N ( {\hat{x}}_{t} , NOTHING ) \vert < {δ}_{N} ( limit network disturbance )$$

where xₜ represents the location of the mobile device at time t, aₜ is the action from the planner, H is the planning horizon, f is the motion model of the mobile device (given by the environment), \hat{x}ₜ is the location of the mobile device according to the production plan (if not re-routed), N is a function that estimates the load of the network at a given time (used to measure the effect of active measurements on the network), and R(xₜ, aₜ) is the score function, as an example of the score function(s) C-1 . . . C-X in FIG. 2B.

The output of the planning algorithm is a sequence of actions for the autonomous or automated mobile device(s) 12. An action for mobile device can be the following: go to a location, turn on data collection, and generate synthetic load. In the first case, the algorithm can instruct a mobile device to be re-routed from its nominal route given by the current operations. When the mobile device is visiting a location that has promising data, data collection can be turned on in passive or active mode. In the case where the data point requires a high load, the mobile device can be instructed to generate a high load when visiting a particular area, e.g., referred to it as active measurement.

Note that an action might be simply communication-related suitable for any mobile devices (e.g., generate load at a given zone in the factory, etc.), while the more general planning with mobile devices also include motion-type actions from the planner within their respective constraints.

This problem can be generalized to be solved for multiple mobile devices. The optimization problem can be solved at a regular interval, e.g., when there is a change in the environment or when there is a change in the data enrichment analysis phase.

Note, however, that the score function is expected to change over time as the heatmap(s) are updated. Whenever the score function changes, the planning problem can be solved again to re-route the mobile device(s) 12.

The last step of the loop cycle is to execute the plan for data enrichment (Block 160). There are two basic types of measurements performed by the automated or autonomous mobile device(s) 12. In the case of passive measurements, the measurements are performed in a non-intrusive way, so it does not impact the ongoing traffic of the mobile devices in any way. In the case of active measurements, specific test traffic is generated and the measurements are performed on that test traffic. The active measurements have multiple benefits: it enables extra features representing the characteristics of the test traffic, while it gives the possibility to create conditions that are rarely seen, e.g. generate load, interference.

In some embodiments, at execution time, an additional safety check is used to verify that the proposed action from the planner is still safe. The planner in some embodiments already includes safety constraints, but depending on the algorithm used for planning the constraints might not be hard constraints. In addition, there might be discrepancies between the actual environment and the representation from the planning step.

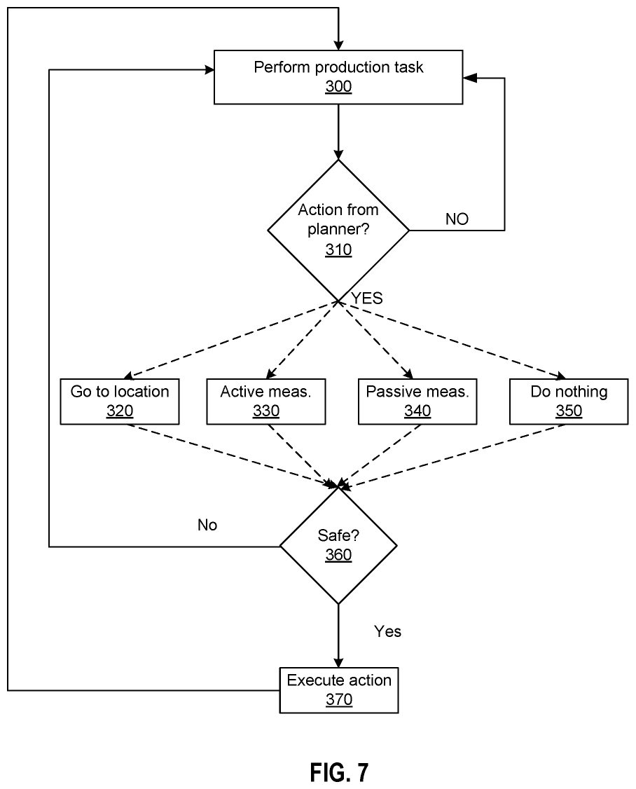

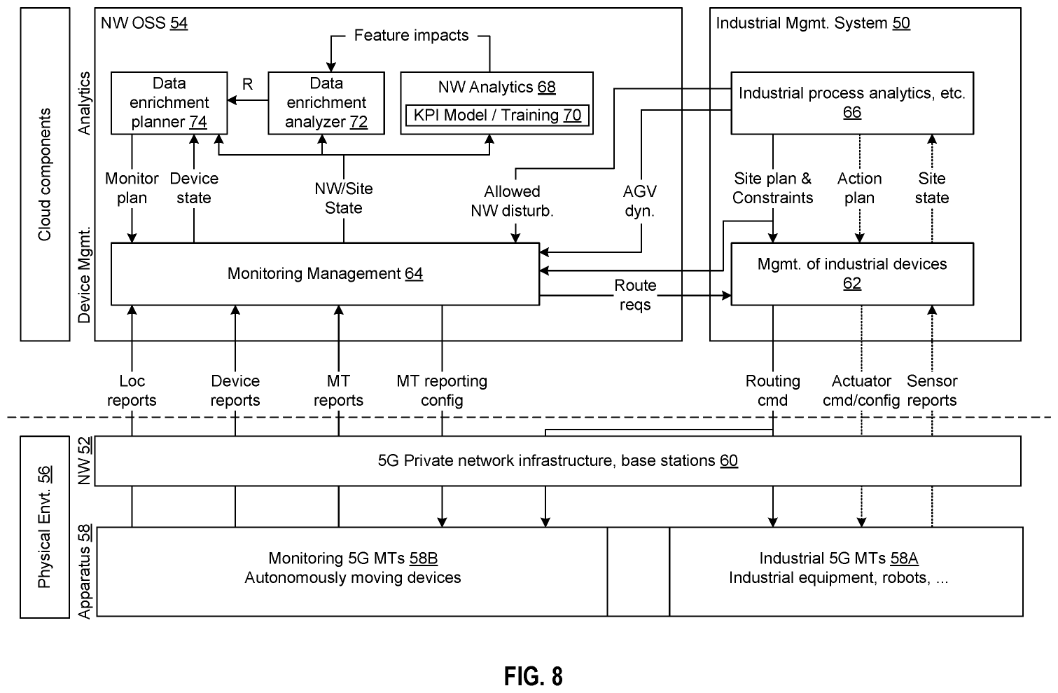

FIG. 7 shows the execution plan of an autonomous or automated mobile device 12 according to some embodiments in this regard. As shown, the autonomous or automated mobile device 12 performs its production task (Block 300). If the autonomous or automated mobile device 12 has been configured by the planner to perform one or more actions (YES at Block 310), then the configured action(s) may include going to a location (Block 320), performing active measurement(s) (Block 330), performing passive measurement(s) (Block 340), and/or doing nothing (Block 350). Before performing the configured action(s) at execution time, though, the autonomous or automated mobile device 12 or another node (e.g., management of industrial devices 62 in FIG. 8) checks whether performing the configured action(s) is safe (Block 360). In one embodiment, then, the planner configures the autonomous or automated mobile device 12 to perform the action(s), but the safety of the action(s) may have changed by the time the autonomous or automated mobile device 12 is to execute the action(s) at execution time. The autonomous or automated mobile device 12 in this case double checks the safety of the configured action(s) at execution time before executing the action(s). If the configured action(s) are not safe at execution time (NO at Block 360), then the autonomous or automated mobile device 12 aborts the configured action(s) and reverts to performing its production task (Block 300). But if the configured action(s) are (still) safe at execution time (YES at Block 360), then the autonomous or automated mobile device 12 proceeds to execute the action(s) (Block 370) before reverting back to its production task.

Consider now an example implementation for an embodiment where the non-public communication network 10 provides communication service in an industrial environment. In this example, the automated or autonomous mobile device(s) 12 may include AGV and/or UAV moving autonomously to perform tasks related to the industrial processes, e.g., carrying load. The location of the AGVs/UAVs may be determined by applying technologies such as, e.g., Simultaneous Localization and Mapping (SLAM) using cameras or LIDAR. In one embodiment, the AGVs/UAVs can be instructed remotely to move to certain places. In some embodiments, the non-public communication network 10 uses 5th generation (5G) cellular telecommunication technology for communication. In this case, the machines and devices (e.g., robotic arms, AGVs, UAVs, sensors, cameras) may be equipped with mobile terminals that are connected to the 5G network. In the 5G network, various communication services are used, e.g., Ultra Reliable Low Latency Communication (URLLC) for latency critical use cases such as robot control, massive Machine Type Communication (mMTC) for other Machine to Machine (M2M) communication, etc. In one embodiment, the 5G network is managed and optimized by an Operations Support System (OSS). The network in this regard may be monitored both at the node level and the mobile terminal level. Based on collected measurement data, the machine learning model 14 may be trained for various purposes such as root-cause analysis, anomaly detection.

In this context, FIG. 8 shows the high-level system architecture components according to one example implementation where embodiments herein are integrated into an industrial site management system 50 and where 5G network (NW) infrastructure 52 is managed by a Network OSS (NW OSS) 54.

In any event, as shown, the physical environment 56 is composed of industrial apparatus 58 and NW infrastructure devices 60, e.g., base stations. The industrial apparatus 58 in this example include both industrial 5G mobile terminals 58A, such as industrial equipment, robots, etc., but automated or autonomous mobile devices in the form of autonomously moving devices and/or other monitoring 5G mobile terminals 58B. The site is monitored by Sensors and decided action commands are sent to Actuators.

Local or remote cloud components include logical modules for device management and analytics. The roles of device connectors, i.e., data collectors and command sending functionalities, are collected through the 5G Private NW 52 into a Management of Industrial Devices module 62 and a Monitoring Management module 64.

The management modules 62, 64 expose the collected reports from Industrial 5G MTs (e.g., connected industrial equipment and robots) and autonomously moving devices used as Monitoring MTs of the 5G NW 52. As depicted in FIG. 8, these two device types share some common parts, e.g., industrial AGVs are at the same time used for NW data collection as well. In addition, the Monitoring Management module 64 receives a site plan and constraints, AGV dynamics, and allowed NW disturbance information from an industrial process analytics system 66. From all this collected information, the Monitoring Management module 64 can create a NW and Site state for a given time window to be presented towards a NW Analytics module 68 and Data enrichment modules that include a Data enrichment planner 74 and a Data enrichment analyzer 72.

With the Feature impacts reported from a Model training module 70 and NW/Site state information, the Data enrichment analyzer 72 can create score function R(x,a) value(s). With the Device state exposed from the Monitoring Management module 64, the Data enrichment planner 74 can create a Monitoring plan. The Data enrichment planner 74 sends the Monitoring plan to the Monitoring Management module 64, which provides Route requirements to the Management of Industrial Devices module 62 in the Industrial Management System 50. The Management of Industrial Devices module 62 in the Industrial Management System 50 creates the Routing commands based on these Route requirements. MT reporting configurations are also issued by the Monitoring Management module 64 to each MT according to the new plan.

In FIG. 8's example, the KPI Model/Training module 70 implements the model trainer 16 and model validator 22 in FIG. 1. The Data enrichment analyzer 72 and the Data enrichment planner 74 in FIG. 8 implement one or more functions of the controller 24 in FIG. 1, e.g., determining what additional training data to add to the training dataset and determining how to configure autonomous or automated mobile device(s) to help collect the additional training data. Depending on the particular implementation, the Monitoring Management module 64 and/or the Management of Industrial Devices module 62 may implement one or more functions of the controller 24 as well, e.g., determining route(s) that the autonomous or automated mobile device(s) are to take in order to help collect the additional training data and/or actually configuring the device(s) to take the determine route(s). In some embodiments, the signaling 40 from FIG. 1 for configuring the automated or autonomous mobile device(s) 12 corresponds to the monitoring plan from the Data enrichment planner 74, the route requirements from the Monitoring Management module 64, and/or the routing commands from the Management of Industrial Devices module 62.

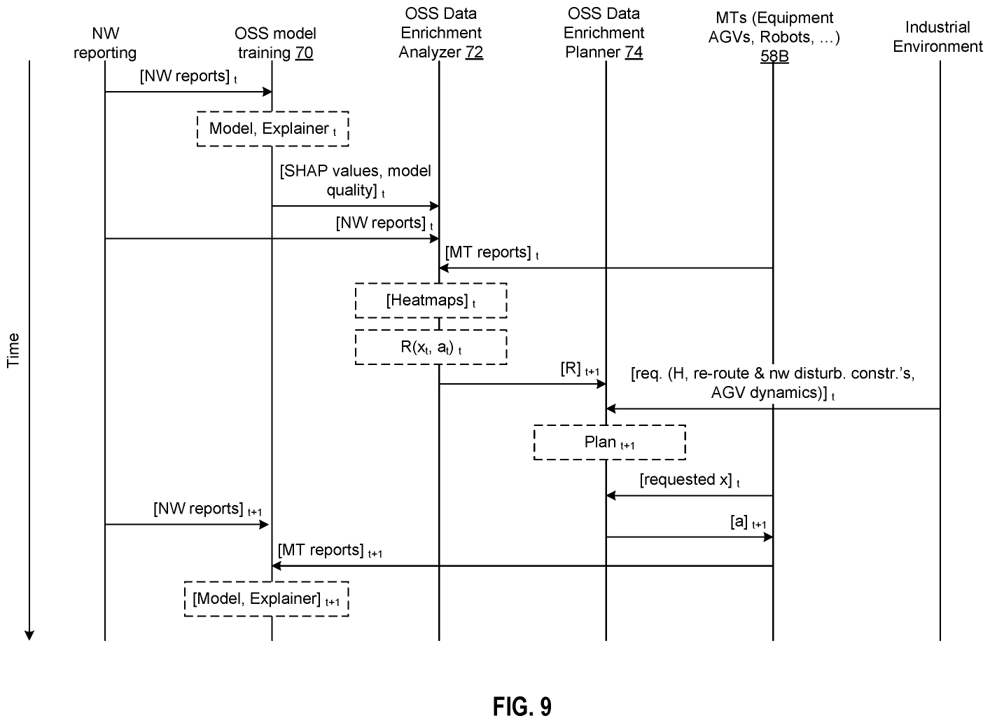

FIG. 9 shows corresponding signaling for realizing some embodiments in this example. As shown, OSS model training module 70 performs model training based on NW reports. OSS model training module 70 provides SHAP values and model quality information to the OSS Data Enrichment Analyzer 72. Based on the SHAP values, model quality information, NW reports, and MT reports, the OSS Data Enrichment Analyzer 72 generates heatmap(s) and score function(s) R(x,a). The OSS Data Enrichment Analyzer 72 in turn provides the score function(s) R(x,a) to the OSS Data Enrichment Planner 74. Based on the score function(s) and information from the Industrial Environment (e.g., re-routing restrictions, network disturbance constraints, AGV dynamics), the OSS Data Enrichment Planner 74 determines a data collection plan and requests the MTs to perform action(s) to execute that data collection plan. As a result of this, the NW provides additional NW reports and/or the MTs provide additional MT reports, for use by the OSS model training module 70 in re-training the machine learning model.

Note that, in some embodiments, the training data collected may consist of performance management (PM) data such as node reports, event logs, counters, interface probing, etc. Measurements underlying the PM data may include for example channel quality index, Reference Signal Received Power (RSRP), Reference Signal Received Quality (RSRQ), etc. These or other measurements can be performed by the Mobile Terminals (MT, also known as User Equipment in public networks) and the results may be collected and reported by the access point serving each MT. Some embodiments may instruct MTs to perform these measurements in the context of Minimization of Drive Test (MDT, 3GPP TS 37.320 V17.1.0). In these and other embodiments, the measurement results may be collected in the OSS.

The aim of performance management is to assure that the quality of the provided services is kept at a certain level and that Key Performance Indicators (KPIs) are within a desired range. When performance degradation occurs, the OSS has to detect it. It is done by monitoring KPIs periodically. After the detection of the KPI degradation, the problem is localized, and the root cause of the problem is found. With embodiments herein, root-cause analysis can be performed in an autonomous, data-driven way, where ML methods are involved to learn the specific characteristics of the environment. Once the root-cause is found, actions can be taken to fix or mitigate the problem.

As this example demonstrates, then, some embodiments herein are applicable in a context where machine learning model training proves challenging because the non-public communication network 10 provides communication service for applications or services with strict performance requirements, e.g., mission-critical applications where the reliability of the machine learning model 14 is of utmost importance. In this context, though, some embodiments herein exploit one or more opportunities that exist due to the non-public nature of the communication network 10 and/or due to the type of applications or services for which the non-public communication network 10 is deployed. Some embodiments for example exploit automated or autonomous operations that are deployed for the purpose of performing functional tasks (e.g., conveyer belts, robotic arms, AGVs, and/or other automated or autonomous mobile devices) also for the purpose of training data collection. Alternatively or additionally, some embodiments exploit high-resolution device localization opportunities that exist, in part, because of the non-public nature of the communication network 10 and/or because of the applications or services for which the communication network 10 is deployed. Some embodiments in this regard exploit localization technologies such as Light Detection and Ranging (LIDAR) based Simultaneous Localization and Mapping (SLAM), e.g., for reporting the location at which active or passive measurements are performed.

Some embodiments herein may therefore generally provide an automated data enrichment design for improving machine learning training performance. Some embodiments for example exploit the mobility of AGVs, UAVs, and/or other automated or autonomous mobile devices, combined with planning ability, to enable automated data collection, e.g., for enhancing sensing, providing mobile base stations, and/or mapping global network performance. Some embodiments accordingly provide an approach in an industrial factory environment that tackles challenges of ML model training in non-public communication networks by utilizing opportunities given in the non-public communication networks.

Some embodiments in this regard provide a method for smart data collection using autonomous or automated mobile device(s) 12 for improving machine learning models in a non-public communication network, e.g., including data enrichment analysis and data enrichment planning as described above. Such data enrichment analysis involves determining what training data to collect in the context of a non-public communication network, whereas data enrichment planning involves using automated or autonomous mobile device(s) 12 to perform the data collection in an optimal way. Some embodiments accordingly take advantage of the private environment for scheduling data collection using a planning algorithm. Some embodiments for example enrich a machine learning training dataset using active and/or opportunistic measurements from automated or autonomous mobile device(s) that are configured to perform a functional task, e.g., in an industrial environment.

Some embodiments more particularly resolve a trade-off between opportunistic and active measurements with autonomous or automated mobile device(s) 12 in a non-public communication network 10. For example, some embodiments find what training data should be collected to improve a machine learning model based on an existing training dataset and a current heatmap of the network performance. In one embodiment, the value of a measurement location and data enrichment action is given by a score function that is automatically generated and dynamically updated based on the heatmap(s) and the performance of the machine learning model. Alternatively or additionally, the mobile device navigation strategy may be computed by an optimization algorithm taking into account environment constraints. Some embodiments in this regard autonomously guide mobile devices to collect the training data.

Certain embodiments may provide one or more of the following technical advantage(s). Some embodiments herein provide improved observability within a non-public communication network and/or provide more accurate and/or more robust ML models, enabling better network management, network optimization solutions, and/or network automation. Some embodiments alternatively or additionally exploit live heatmap of network measurements and KPIs.

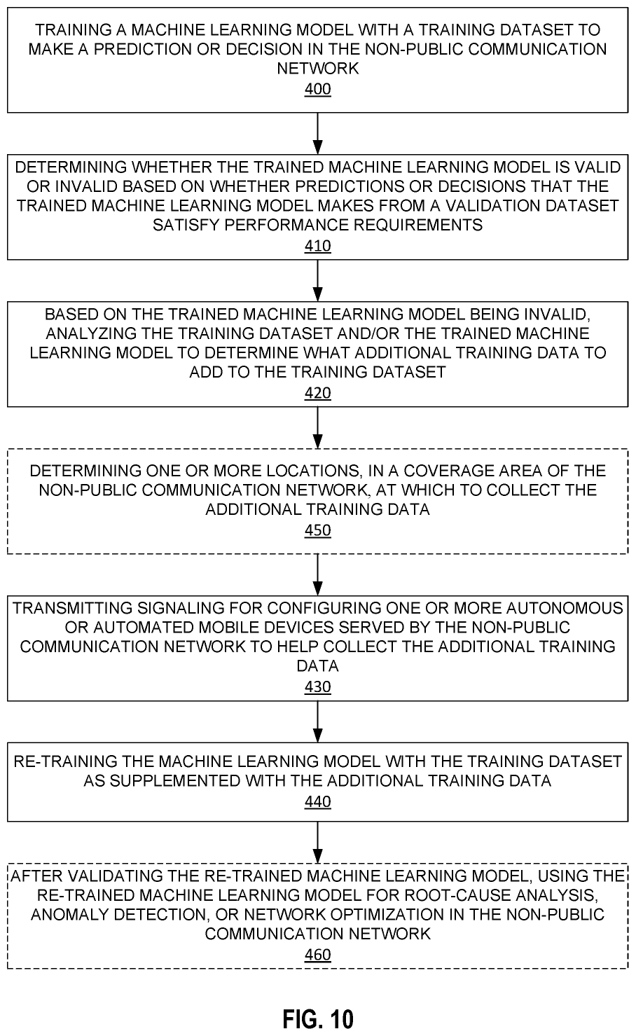

In view of the modifications and variations herein, FIG. 10 depicts a method according to some embodiments. The method is performed by equipment that supports the non-public communication network 10. The equipment may for instance be network equipment that is a part of the non-public communication network 10, or may be Operations Support System (OSS) equipment that is part of an OSS for the non-public communication network 10.

As shown, the method comprises training a machine learning model 14 with a training 18 dataset to make a prediction or decision in the non-public communication network 10 (Block 400). The method further comprises determining whether the trained machine learning model 14T is valid or invalid based on whether predictions or decisions that the trained machine learning model 14T makes from a validation dataset satisfy performance requirements 21 (Block 410). The method further comprises, based on the trained machine learning model 14T being invalid, analyzing the training dataset 18 and/or the trained machine learning model 14T to determine what additional training data 18D to add to the training dataset 18 (Block 420).

Notably, the method further comprises transmitting signaling 40 for configuring one or more autonomous or automated mobile devices 12 served by the non-public communication network 10 to help collect the additional training data 18D (Block 430).

The method also comprises re-training the machine learning model 14 with the training dataset 18 as supplemented with the additional training data 18D (Block 440).

In some embodiments, the analyzing step 420 comprises analyzing how impactful different machine learning features represented by the training dataset are to the prediction or decision and selecting one or more machine learning features for which to collect additional training data, based on how impactful the one or more machine learning features are to the prediction or decision.

In some embodiments, the analyzing step 420 comprises, for each of one or more machine learning features represented by the training dataset, analyzing a number of and/or a diversity of values in the training dataset for the machine learning feature, and selecting one or more machine learning features for which to collect additional training data, based on said number and/or said diversity.

In some embodiments, the method further comprises determining one or more locations, in a coverage area of the non-public communication network, at which to collect the additional training data (Block 450). In this case, the signaling 40 may comprise signaling 40 for configuring the one or more autonomous or automated mobile devices 12 to help collect the additional training data at the one or more locations.

In some embodiments, determining the one or more locations at which to collect the additional training data comprises the following steps for each of one or more machine learning features. A first step is generating a heatmap representing values of the machine learning feature at different locations in the coverage area of the non-public communication network. Based on the heatmap, a second step is generating a score function representing scores for respective locations in the coverage area of the non-public communication network. In some embodiments, the score for a location quantifies a benefit of collecting additional training data for the machine learning feature at the location. Regardless, based on the score function, a third step is selecting one or more locations at which to collect additional training data for the machine learning feature.

In some embodiments, the score function represents the score for a location as a function of a number of and/or a diversity of values in the training dataset for the machine learning feature at the location. In other embodiments, the score function alternatively or additionally represents the score for a location as a function of an accuracy of the machine learning model at the location. In yet other embodiments, the score function alternatively or additionally represents the score for a location as a function of an uncertainty of the machine learning model at the location.

In some embodiments, the signaling 40 comprises, for each of at least one of the one or more autonomous or automated mobile devices 12, signaling 40 for routing the autonomous or automated mobile device to at least one location of the one or more locations to help collect at least some of the additional training data. In some embodiments, for example, the signaling 40 revises a route of the autonomous or automated mobile device to include the at least one location as a destination or waypoint in the route.

In some embodiments, for each of at least one of the one or more autonomous or automated mobile devices 12, the signaling 40 comprises signaling 40 for configuring the autonomous or automated mobile device to perform one or more transmissions of test traffic at one or more of the one or more locations. In other embodiments, for each of at least one of the one or more autonomous or automated mobile devices 12, the signaling 40 alternatively or additionally comprises signaling for configuring the autonomous or automated mobile device to perform one or more measurements at one or more of the one or more locations and to collect the results of the one or more measurements as at least some of the additional training data.

In some embodiments, the method further comprises solving an optimization problem that optimizes a data collection plan for each of the one or more autonomous or automated mobile devices 12, subject to one or more constraints. In this case, a data collection plan for an autonomous or automated mobile device includes a plan on what training data the autonomous or automated mobile device will help collect and what route the autonomous or automated mobile device will take as part of helping to collect that training data. In some embodiments, the one or more constraints include a constraint on movement dynamics of each of the one or more autonomous or automated mobile devices 12. In other embodiments, the one or more constraints alternatively or additionally include a constraint on allowed deviation from a production route of each of the one or more autonomous or automated mobile devices 12. In yet other embodiments, the one or more constraints alternatively or additionally include a constraint on an extent to which collection of additional training data is allowed to disturb the non-public communication network. In some embodiments, a score function for a machine learning feature represents scores for respective locations in the coverage area of the non-public communication network. In this case, the score for a location quantifies a benefit of collecting additional training data for the machine learning feature at the location, and solving the optimization problem comprises maximizing the score function over a planning time horizon, subject to the one or more constraints.

In some embodiments, the training data includes performance management data and/or configuration management data for the non-public communication network.

In some embodiments, the prediction is a prediction of one or more key performance indicators, KPIs.

In some embodiments, the non-public communication network is an industrial internet-of-things network. In this case, the autonomous or automated mobile devices 12 are each configured to perform a task of an industrial process, and the autonomous or automated mobile devices 12 include one or more automated guided vehicles, one or more autonomous mobile robots, and/or one or more unmanned aerial vehicles.

In some embodiments, the method further comprises, after validating the re-trained machine learning model, using the re-trained machine learning model for root-cause analysis, anomaly detection, or network optimization in the non-public communication network (Block 460).

Embodiments herein also include corresponding equipment for performing the method in FIG. 10. Embodiments herein for instance include equipment configured to perform any of the steps of the method in FIG. 10.

Embodiments also include equipment comprising processing circuitry and power supply circuitry. The processing circuitry is configured to perform any of the steps of any of the embodiments described above for the equipment. The power supply circuitry is configured to supply power to the equipment.

Embodiments further include equipment comprising processing circuitry. The processing circuitry is configured to perform any of the steps of any of the embodiments described above for the equipment. In some embodiments, the equipment further comprises communication circuitry.

Embodiments further include equipment comprising processing circuitry and memory. The memory contains instructions executable by the processing circuitry whereby the equipment is configured to perform any of the steps of any of the embodiments described above for the equipment.

More particularly, the equipment described above may perform the methods herein and any other processing by implementing any functional means, modules, units, or circuitry. In one embodiment, for example, the equipment comprise respective circuits or circuitry configured to perform the steps shown in FIG. 10. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

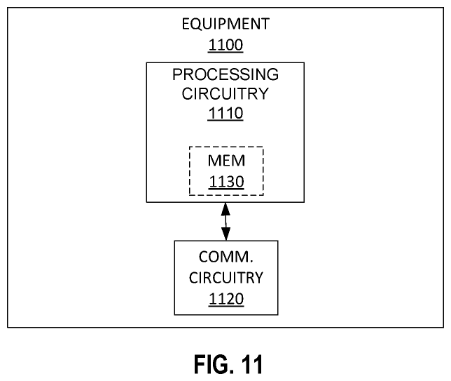

FIG. 11 illustrates equipment 1100 as implemented in accordance with one or more embodiments. As shown, the equipment 1100 includes processing circuitry 1110 and communication circuitry 1120. The communication circuitry 1120 is configured to transmit and/or receive information to and/or from one or more other nodes, e.g., via any communication technology. The processing circuitry 1110 is configured to perform processing described above, e.g., in FIG. 10, such as by executing instructions stored in memory 1130. The processing circuitry 1110 in this regard may implement certain functional means, units, or modules.

Those skilled in the art will also appreciate that embodiments herein further include corresponding computer programs.

A computer program comprises instructions which, when executed on at least one processor of equipment, cause the equipment to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of equipment, cause the equipment to perform as described above.

Embodiments further include a computer program product comprising program code portions for performing the steps of any of the embodiments herein when the computer program product is executed by equipment. This computer program product may be stored on a computer readable recording medium.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method performed by equipment supporting a non-public communication network, the method comprising:
training a machine learning model with a training dataset to make a prediction or decision in the non-public communication network;
determining whether the trained machine learning model is valid or invalid based on whether predictions or decisions that the trained machine learning model makes from a validation dataset satisfy performance requirements;
based on the trained machine learning model being invalid, analyzing the training dataset and/or the trained machine learning model to determine what additional training data to add to the training dataset;
transmitting signaling for configuring one or more autonomous or automated mobile devices served by the non-public communication network to help collect the additional training data; and
re-training the machine learning model with the training dataset as supplemented with the additional training data.

2. The method of claim 1, wherein said analyzing comprises analyzing how impactful different machine learning features represented by the training dataset are to the prediction or decision and selecting one or more machine learning features for which to collect additional training data, based on how impactful the one or more machine learning features are to the prediction or decision.

3. The method of claim 1, wherein said analyzing comprises, for each of one or more machine learning features represented by the training dataset, analyzing a number of and/or a diversity of values in the training dataset for the machine learning feature, and selecting one or more machine learning features for which to collect additional training data, based on said number and/or said diversity.

4. The method of claim 1, further comprising determining one or more locations, in a coverage area of the non-public communication network, at which to collect the additional training data, and wherein the signaling comprises signaling for configuring the one or more autonomous or automated mobile devices to help collect the additional training data at the one or more locations.

5. The method of claim 4, wherein determining the one or more locations at which to collect the additional training data comprises:
for each of one or more machine learning features, generating a heatmap representing values of the machine learning feature at different locations in the coverage area of the non-public communication network;
based on the one or more heatmaps, generating a score function representing scores for respective locations in the coverage area of the non-public communication network, wherein the score for a location quantifies a benefit of collecting additional training data at the location; and
based on the score function, selecting one or more locations at which to collect additional training data.

6. The method of claim 5, wherein the score function represents the score for a location as a function of one or more of:
a number of and/or a diversity of values in the training dataset at the location; and/or
an accuracy of the machine learning model at the location; and/or
an uncertainty of the machine learning model at the location.

7. The method of claim 4, wherein the signaling comprises, for each of at least one of the one or more autonomous or automated mobile devices, signaling for routing the autonomous or automated mobile device to at least one location of the one or more locations to help collect at least some of the additional training data.

8. The method of claim 7, wherein the signaling revises a route of the autonomous or automated mobile device to include the at least one location as a destination or waypoint in the route.

9. The method of claim 4, wherein, for each of at least one of the one or more autonomous or automated mobile devices, the signaling comprises signaling for configuring the autonomous or automated mobile device to:
perform one or more transmissions of test traffic at one or more of the one or more locations; and/or
perform one or more measurements at one or more of the one or more locations and to collect the results of the one or more measurements as at least some of the additional training data.

10. The method of claim 1, further comprising solving an optimization problem that optimizes a data collection plan for each of the one or more autonomous or automated mobile devices, subject to one or more constraints, wherein a data collection plan for an autonomous or automated mobile device includes a plan on what training data the autonomous or automated mobile device will help collect and what route the autonomous or automated mobile device will take as part of helping to collect that training data, wherein the one or more constraints include one or more of:
a constraint on movement dynamics of each of the one or more autonomous or automated mobile devices; and/or
a constraint on allowed deviation from a production route of each of the one or more autonomous or automated mobile devices; and/or
a constraint on an extent to which collection of additional training data is allowed to disturb the non-public communication network.

11. The method of claim 10, wherein a score function represents scores for respective locations in the coverage area of the non-public communication network, wherein the score for a location quantifies a benefit of collecting additional training data at the location, and wherein solving the optimization problem comprises maximizing the score function over a planning time horizon, subject to the one or more constraints.

12. The method of claim 1, wherein the training data includes performance management data and/or configuration management data for the non-public communication network.

13. The method of claim 1, wherein the non-public communication network is an industrial internet-of-things network, wherein the autonomous or automated mobile devices are each configured to perform a task of an industrial process, and wherein the autonomous or automated mobile devices include one or more automated guided vehicles, one or more autonomous mobile robots, and/or one or more unmanned aerial vehicles.

14. The method of claim 1, further comprising, after validating the re-trained machine learning model, using the re-trained machine learning model for root-cause analysis, anomaly detection, or network optimization in the non-public communication network.

15. Equipment configured to support a non-public communication network, the equipment comprising processing circuitry configured to:
train a machine learning model with a training dataset to make a prediction or decision in the non-public communication network;
determine whether the trained machine learning model is valid or invalid based on whether predictions or decisions that the trained machine learning model makes from a validation dataset satisfy performance requirements;
based on the trained machine learning model being invalid, analyze the training dataset and/or the trained machine learning model to determine what additional training data to add to the training dataset;
transmit signaling for configuring one or more autonomous or automated mobile devices served by the non-public communication network to help collect the additional training data; and
re-train the machine learning model with the training dataset as supplemented with the additional training data.

16. The equipment of claim 15, wherein the processing circuitry is configured to analyze how impactful different machine learning features represented by the training dataset are to the prediction or decision and select one or more machine learning features for which to collect additional training data, based on how impactful the one or more machine learning features are to the prediction or decision.

17. The equipment of claim 15, wherein the processing circuitry is configured to, for each of one or more machine learning features represented by the training dataset, analyze a number of and/or a diversity of values in the training dataset for the machine learning feature, and select one or more machine learning features for which to collect additional training data, based on said number and/or said diversity.

18. The equipment of claim 15, wherein the processing circuitry is further configured to determine one or more locations, in a coverage area of the non-public communication network, at which to collect the additional training data, and wherein the signaling comprises signaling for configuring the one or more autonomous or automated mobile devices to help collect the additional training data at the one or more locations.

19. The equipment of claim 18, wherein the processing circuitry is configured to determine the one or more locations at which to collect the additional training data by:
for each of one or more machine learning features, generating a heatmap representing values of the machine learning feature at different locations in the coverage area of the non-public communication network;
based on the one or more heatmaps, generating a score function representing scores for respective locations in the coverage area of the non-public communication network, wherein the score for a location quantifies a benefit of collecting additional training data at the location; and
based on the score function, selecting one or more locations at which to collect additional training data.

20. The equipment of claim 19, wherein the score function represents the score for a location as a function of one or more of:
a number of and/or a diversity of values in the training dataset at the location; and/or
an accuracy of the machine learning model at the location; and/or
an uncertainty of the machine learning model at the location.

21. The equipment of claim 18, wherein the signaling comprises, for each of at least one of the one or more autonomous or automated mobile devices, signaling for routing the autonomous or automated mobile device to at least one location of the one or more locations to help collect at least some of the additional training data.

22. The equipment of claim 21, wherein the signaling revises a route of the autonomous or automated mobile device to include the at least one location as a destination or waypoint in the route.

23. The equipment of claim 18, wherein, for each of at least one of the one or more autonomous or automated mobile devices, the signaling comprises signaling for configuring the autonomous or automated mobile device to:
perform one or more transmissions of test traffic at one or more of the one or more locations; and/or
perform one or more measurements at one or more of the one or more locations and to collect the results of the one or more measurements as at least some of the additional training data.

24. The equipment of claim 15, wherein the processing circuitry is further configured to solve an optimization problem that optimizes a data collection plan for each of the one or more autonomous or automated mobile devices, subject to one or more constraints, wherein a data collection plan for an autonomous or automated mobile device includes a plan on what training data the autonomous or automated mobile device will help collect and what route the autonomous or automated mobile device will take as part of helping to collect that training data, wherein the one or more constraints include one or more of:
a constraint on movement dynamics of each of the one or more autonomous or automated mobile devices; and/or
a constraint on allowed deviation from a production route of each of the one or more autonomous or automated mobile devices; and/or
a constraint on an extent to which collection of additional training data is allowed to disturb the non-public communication network.

25. The equipment of claim 24, wherein a score function represents scores for respective locations in the coverage area of the non-public communication network, wherein the score for a location quantifies a benefit of collecting additional training data at the location, and wherein the processing circuitry is configured to solve the optimization problem by maximizing the score function over a planning time horizon, subject to the one or more constraints.

26. The equipment of claim 15, wherein the training data includes performance management data and/or configuration management data for the non-public communication network.

27. The equipment of claim 15, wherein the non-public communication network is an industrial internet-of-things network, wherein the autonomous or automated mobile devices are each configured to perform a task of an industrial process, and wherein the autonomous or automated mobile devices include one or more automated guided vehicles, one or more autonomous mobile robots, and/or one or more unmanned aerial vehicles.

28. The equipment of claim 15, wherein the processing circuitry is further configured to, after validating the re-trained machine learning model, use the re-trained machine learning model for root-cause analysis, anomaly detection, or network optimization in the non-public communication network.

29. A computer readable storage medium on which is stored instructions that, when executed by at least one processor of equipment configured to support a non-public communication network, causes the equipment to:
train a machine learning model with a training dataset to make a prediction or decision in the non-public communication network;
determine whether the trained machine learning model is valid or invalid based on whether predictions or decisions that the trained machine learning model makes from a validation dataset satisfy performance requirements;
based on the trained machine learning model being invalid, analyze the training dataset and/or the trained machine learning model to determine what additional training data to add to the training dataset;
transmit signaling for configuring one or more autonomous or automated mobile devices served by the non-public communication network to help collect the additional training data; and
re-train the machine learning model with the training dataset as supplemented with the additional training data.
